(19) United States
(12) Patent Application Publication
(10) Pub. No.: US 2024/0387888 A1
(43) Pub. Date: Nov. 21, 2024

(54) BATTERY PACK AND ELECTRICAL DEVICE

(71) Applicant: Koki Holdings Co., Ltd., Tokyo (JP)

(72) Inventors: Kiyoto MATSUOKA, Ibaraki (JP); Tomomasa NISHIKAWA, Ibaraki (JP)

(73) Assignee: Koki Holdings Co., Ltd., Tokyo (JP)

(21) Appl. No.: 18/574,732

(22) PCT Filed: Sep. 28, 2022
(86) PCT No.: PCT/JP2022/036104

§ 371 Date: Dec. 27, 2023

(30) Foreign Application Priority Data
Sep. 29, 2021 (JP) 2021-158765

(51) Int. Cl. H01M 10/42; B25B 21/02; B25F 5/02; H01M 10/48; H01M 50/247

(52) U.S. Cl. CPC H01M 10/425; B25F 5/02; H01M 10/482; H01M 50/247; B25B 21/02; H01M 2220/30

(57) ABSTRACT

One or more sensors are provided on a battery pack side and sensor information is transmitted from the battery pack side to an electrical device main body side to enable a control part of an electrical device main body to perform control using the sensor information. Sensors are provided at a battery pack to collect and output physical information that arises due to external factors. A control part of the battery pack transmits, to the electrical device main body side, signals detected by the sensors directly or after adding up the signals. The control part of the electrical device main body controls operation of the electrical device main body by using the sensor information acquired via a signal terminal.

### CROSS-REFERENCE TO RELATED APPLICATION

This application is a 371 application of the International PCT application serial no. PCT/JP2022/036104, filed on Sep. 28, 2022, which claims the priority benefits of Japan Patent Application No. 2021-158765, filed on Sep. 29, 2021. The entirety of each of the above-mentioned patent applications is hereby incorporated by reference herein and made a part of this specification.

### TECHNICAL FIELD

The present invention relates to a battery pack and an electrical device.

### RELATED ART

Portable electrical devices powered by battery packs are widely used. Such well-known technology is disclosed, for example, in Patent Document 1. Patent Document 1 discloses an adapter that is mounted between a battery pack and an electrical device main body and includes a tilt sensor, a control part, and a signal output terminal. The adapter in Patent Document 1 is configured such that, upon detecting that a tilt detected by the tilt sensor is greater than a predetermined value, a control part of the adapter outputs a stop signal from the signal output terminal to the electrical device main body to cut off power supply from the battery pack to the electrical device main body. Since the adapter disclosed in Patent Document 1 is mounted between the battery pack and the electrical device main body, the overall size of the electrical device increases and the operability deteriorates compared to the case where the adapter is not mounted. Thus, a configuration that suppresses an increase in size of the electrical device by providing the sensor at the battery pack is described in Patent Document 2.

Patent Document 2 discloses an impact tool in which an acceleration sensor and a control part are provided at a battery pack, impacts caused by an impact tool main body are detected by the control part on the battery pack side, and the control part turns off a switching element provided on the battery pack side to cut off power supply from the battery pack to the impact tool main body.

### RELATED ART DOCUMENTS

### Patent Documents

Patent Document 1: Japanese Patent Application Laid-Open No. 2019-042850
Patent Document 2: Japanese Patent Application Laid-Open No. 2005-224909

### SUMMARY OF INVENTION

### Problems to be Solved by Invention

However, the impact tool of Patent Document 2 cuts off power supply within the battery pack according to the determination of the battery pack. Thus, although it is possible to detect impacts in the case of being connected to an impact tool that generates a large impact force, there is a problem that it is not possible to detect impacts in the case of being connected to an impact tool that generates a small impact force, which is considered to have low versatility. To increase versatility, it is considered useful to perform control corresponding to device information outputted from the connected electrical device main body such as an impact tool. Further, since the battery pack is used when connected to various electrical device main bodies, convenience would be improved if sensors capable of detecting information other than impact detection are provided.

The present invention has been made in view of the above background, and an objective thereof is to provide a battery pack that enables control corresponding to device information outputted from a connected electrical device main body while suppressing an increase in size of an electrical device, and an electrical device using the battery pack.

Another objective of the present invention is to provide a battery pack with improved convenience and an electrical device using the battery pack.

Another objective of the present invention is to provide a battery pack and an electrical device using the battery pack, in which various sensors are provided at the battery pack and sensor information is sent out from the battery pack to an electrical device main body side to enable a control part of the electrical device main body to perform control using sensor information.

### Means for Solving Problems

The following describes representative features in the invention disclosed in this application.

According to one feature of the present invention, in a battery pack including a sensor part configured to collect and output physical information that arises due to external factors of the battery pack and a battery pack control part that is connected to the sensor part, the battery pack control part is configured to output the physical information inputted from the sensor part to the electrical device main body, or generate and output battery pack information related to the physical information to the electrical device main body. Further, it is configured to execute control corresponding to the physical information inputted from the sensor part. Herein, the physical information that arises due to external factors includes information related to a position, a posture, or an acceleration of the battery pack. The battery pack control part is configured to be capable of communicating with a device-side control part of the electrical device main body.

According to another feature of the present invention, the battery pack has a plurality of connection terminals made of metal that enable electrical connection with the electrical device main body, and performs wired communication with the electrical device main body using a part of the connection terminals. The battery pack control part is configured to be capable of changing an operating condition of the electrical device main body according to the physical information detected by the sensor part. Further, the battery pack control part is configured to be capable of changing an operating condition of the electrical device main body according to the electrical device main body connected. An electrical device is realized including such a battery pack and the electrical device main body which includes a battery pack mounting part to which the battery pack is capable of being mounted and a load part driven by the battery pack.

According to still another feature of the present invention, a battery pack capable of being mounted to an electrical device main body having a device-side control part includes: a sensor part configured to collect and output physical information that arises due to external factors of the battery pack; and a battery pack-side control part that is connected to the sensor part and to which device information outputted from the device-side control part is inputted. The battery pack-side control part is configured to transmit a signal controlling the electrical device main body to the electrical device main body in a case where an output signal of the sensor part has been requested from the device-side control part, and to transmit the output signal of the sensor part to the electrical device main body in a case where the output signal of the sensor part is not requested from the device-side control part.

According to still another feature of the present invention, the electrical device main body has a device-side control part, and the device-side control part is configured to control the load part based on information related to a mounting direction of the battery pack with respect to the battery pack mounting part and the physical information or the battery pack information outputted from the battery pack. The device-side control part prohibits driving of the load part in a case where the physical information or the battery pack information does not match the information related to the mounting direction. The information related to the mounting direction of the battery pack with respect to the electrical device main body includes an operation permission range based on the mounting direction of the battery pack in a state in which the electrical device main body is normally placed. The device-side control part prohibits driving of the load part in a case where the physical information or the battery pack information falls outside the operation permission range.

According to still another feature of the present invention, the electrical device main body includes an output part that is capable of outputting light or sound and is capable of rotating, and a device-side control part that controls rotation of the output part. The physical information or the battery pack information includes information related to sound generated around the electrical device main body. The device-side control part is configured to change an output direction or an output value of the light or the sound of the output part based on the information related to the sound. Further, the electrical device includes an adjustment part that is operated by a user and adjusts an output of the output part. The device-side control part is configured to control the output part according to one of a first mode that controls the output part based on the information related to the sound and a second mode that controls the output part based on an operation on the adjustment part.

### Effects of Invention

According to the present invention, it is possible to provide a battery pack and an electrical device capable of performing control corresponding to the device information outputted from the connected electrical device main body while suppressing an increase in size of the electrical device. Further, it is possible to provide a battery pack with improved convenience and an electrical device using the battery pack. Further, according to the present invention, it is possible to provide a battery pack and an electrical device using the battery pack in which various sensors are provided at the battery pack and sensor information is sent out from the battery pack to the electrical device main body side to enable the control part of the electrical device main body to perform control using the sensor information.

### BRIEF DESCRIPTION OF DRAWINGS

FIG. 1 is a perspective view of a main body part of an electrical device main body 201 and a battery pack 1 according to an embodiment of the present invention.

FIG. 2A and FIG. 2B are diagrams of the battery pack 1 in FIG. 1, FIG. 2A is a longitudinal sectional view, and FIG. 2B is a cross-sectional view of an A-A part.

FIG. 3 is a circuit diagram of the battery pack 1 and the electrical device main body 201 shown in FIG. 1.

FIG. 4A and FIG. 4B are schematic diagrams showing an example of installing sound sensors 63 to 66 at the battery pack in FIG. 1.

FIG. 5 is a state transition diagram showing an operation procedure of the battery pack 1 and the electrical device main body 201 according to this embodiment.

FIG. 6 is a state transition diagram for describing a detailed procedure in step 105 in FIG. 5.

FIG. 7 is a flowchart showing a schematic control procedure in a sensor output mode of a control part 50 of the battery pack 1 according to this embodiment.

FIG. 8 is a flowchart showing a detailed procedure of data reception processing 120 in FIG. 7.

FIG. 9 is a flowchart showing a detailed procedure of sensor processing 140 in FIG. 7.

FIG. 10 is a flowchart showing a detailed procedure of data transmission processing 150 in FIG. 7.

FIG. 11 is a block diagram showing an overall configuration of an electrical device main body 301 according to a second embodiment of the present invention.

FIG. 12 is a top view for describing an operation of the electrical device main body 301 in FIG. 11.

FIG. 13 is a block diagram showing a circuit configuration of the electrical device main body 301 according to the second embodiment.

FIG. 14 is a flowchart showing a schematic control procedure in a control part 350 of the electrical device main body 301 according to the second embodiment.

FIG. 15 is a flowchart showing a detailed procedure of startup processing 501 in FIG. 14.

FIG. 16 is a flowchart showing a detailed procedure of data reception processing 502 in FIG. 14.

FIG. 17 is a flowchart showing a detailed procedure of control mode switching processing 503 in FIG. 14.

FIG. 18 is a flowchart showing a detailed procedure of communication standby processing 546 in FIG. 17.

FIG. 19 is a flowchart showing a detailed procedure of sound data processing 505 in FIG. 14.

FIG. 20 is a flowchart showing a detailed procedure of motor control 507 in FIG. 14.

FIG. 21 is a top view for describing a change in an irradiation angle of the electrical device main body 301 in FIG. 11.

FIG. 22A to FIG. 22C are diagrams for describing a method of controlling an electrical device 401 according to a third embodiment using a battery pack 1 of the present invention (Part 1).

FIG. 23A to FIG. 23C are diagrams for describing the method of controlling the electrical device 401 according to the third embodiment using the battery pack 1 of the present invention (Part 2).

FIG. 24A to FIG. 24C are diagrams for describing the method of controlling the electrical device 401 according to the third embodiment using the battery pack 1 of the present invention (Part 3).

FIG. 25A to FIG. 25C are diagrams for describing a method of controlling an electrical device 601 according to a fourth embodiment using a battery pack 1 of the present invention (Part 1).

FIG. 26A to FIG. 26C are diagrams for describing the method of controlling the electrical device 601 according to the fourth embodiment using the battery pack 1 of the present invention (Part 2).

FIG. 27A to FIG. 27C are diagrams for describing the method of controlling the electrical device 601 according to the fourth embodiment using the battery pack 1 of the present invention (Part 3).

FIG. 28 is a flowchart showing a control procedure of a control part 650 of the electrical device main body 601 according to the fourth embodiment.

FIG. 29A and FIG. 29B are perspective views showing an appearance of an electrical device main body (radio) 801 according to a fifth embodiment of the present invention, FIG. 29A is a perspective view viewed from a front upper side, and FIG. 29B is a perspective view viewed from a rear lower side.

FIG. 30 is a block diagram showing a circuit configuration of the electrical device main body 801 shown in FIG. 29A and FIG. 29B and the battery pack 1.

FIG. 31 is a flowchart showing an operation of a control part 850 of the electrical device main body 801 shown in FIG. 29A and FIG. 29B.

FIG. 32 is a flowchart showing a detailed procedure of volume control of step 905 in FIG. 31.

### DESCRIPTION OF EMBODIMENTS

### Embodiment 1

Hereinafter, embodiments of the present invention will be described based on the drawings. In the figures below, the same parts will be labeled with the same reference signs, and repeated descriptions will be omitted. Further, in this specification, front, rear, left, right, up, and down directions refer to directions shown in the figures.

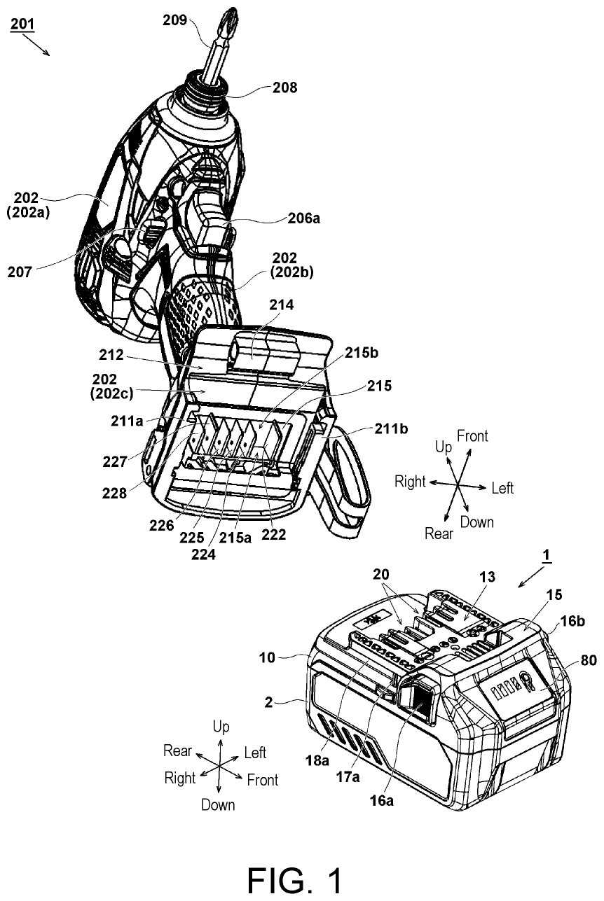

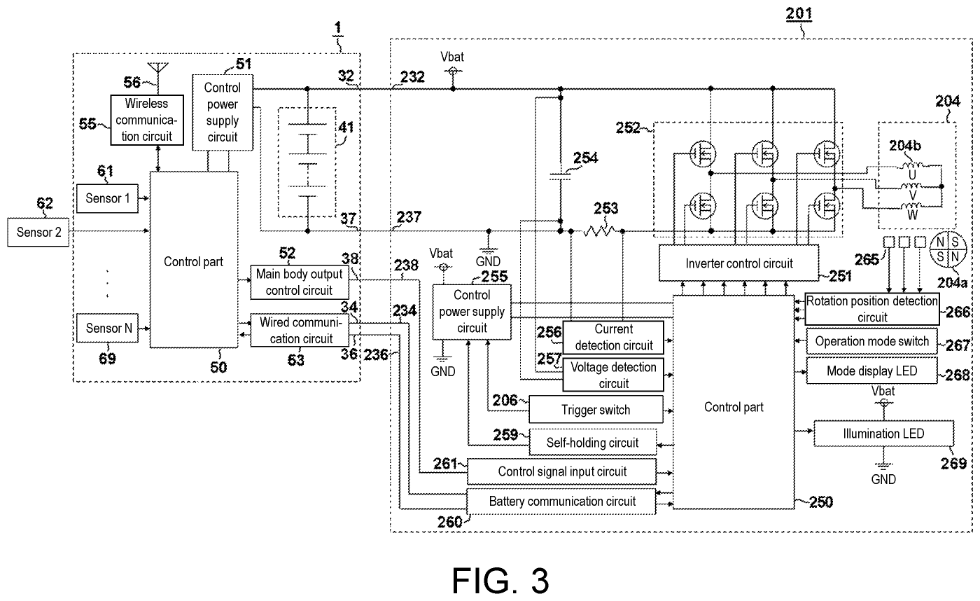

FIG. 1 is a perspective view of a main body part (hereinafter, sometimes referred to as an electrical device main body 201) of an electrical device 201 and a battery pack 1 according to an embodiment of the present invention. An example of an impact tool is shown as the electrical device main body 201. The main body part of the electrical device 201 takes a detachable battery pack 1 as a power source and performs a tightening operation by driving a tip tool 209 using rotational driving force of a motor. The main body part of the electrical device 201 includes a housing 202 that serves as an outer frame that forms an outer shape. The housing 202 is composed of a body part 202a that accommodates a motor and a power transmission mechanism (not shown), a handle part 202b that extends downward from the body part 202a, and a battery pack mounting part 202c that is formed on a lower side of the handle part 202b. At a part of the handle part 202b, a trigger-shaped trigger switch 206 (refer to FIG. 3 for reference sign) is provided and a trigger lever 206a of the trigger switch 206 protrudes. A forward-reverse switching lever 207 for switching a rotation direction of the motor is provided above the trigger switch 206. An anvil (not visible in the figure) serving as an output shaft is provided on a front side of the housing 202, and a tip tool holding part 208 for mounting a tip tool 209 is provided at a tip of the anvil. Herein, a cross-head driver bit is mounted as the tip tool 209.

Rail parts 211a and 211b, which include grooves or rails extending in parallel in a front-rear direction at inner wall portions on both left and right sides, are formed at the battery pack mounting part 202c, and a terminal part (main body-side terminal part) 215 is provided therebetween. The terminal part 215 is manufactured by integral molding of a non-conductive material such as synthetic resin, and includes therein a plurality of terminals made of metal, e.g., a positive electrode input terminal 232, a first signal terminal 234, a second signal terminal 236, a negative electrode input terminal 237, a third signal terminal 238, and a fourth signal terminal 235. The terminal part 215 is manufactured by casting a plurality of metal terminals (232 and 234 to 238) according to the molding of synthetic resin, and is formed to have a vertical surface 215a that serves as an abutment surface in a mounting direction (front-rear direction), and a horizontal surface 215b.

The terminal part 215 is fixed to be sandwiched by an opening portion (not visible in the figure) of the left-right split type battery pack mounting part 202c. The horizontal surface 215b of the terminal part 215 is a surface adjacent to and opposed to an upper stage surface 13 on the battery pack 1 side when mounting the battery pack 1. A curved part 212 that abuts against a raised part 15 of the battery pack 1 is formed on the front side of the horizontal surface 215b, and a protruding part 214 is formed in the vicinity of a left-right center of the curved part 212.

The battery pack 1 is of a type detachable with respect to the main body part of a compatible electrical device 201, and accommodates a plurality of battery cells in a case made of synthetic resin. An upper part of the battery pack 1 is provided with rail grooves 18a and 18b (not visible in FIG. 1) for mounting to the main body part of the electrical device 201, a slot part 20 for realizing electrical connection with the main body part of the electrical device 201, a connection terminal group (to be described later with reference to FIG. 3) arranged at an inner portion of the slot part 20, and a latch mechanism (latch part) for maintaining or releasing a mounting state with the main body part of the electrical device 201. The latch mechanism is composed of latch buttons 16a and 16b and locking claws 17a and 17b (not visible in FIG. 1) that move in conjunction with the latch buttons 16a and 16b. The two rail grooves 18a and 18b (not visible in FIG. 1) are formed at lateral surfaces of an upper case (first case) 10. The rail grooves 18a and 18b are formed such that their longitudinal direction is parallel to the mounting direction of the battery pack 1.

The battery pack 1 accommodates a plurality of battery cells therein and is capable of outputting a rated voltage (e.g., 18 V) of direct current. The voltage of the battery pack 1 and the type of battery cell used may be set in any manner. It is possible to configure an output voltage of the battery pack 1 to be switchable between low/high voltages. After removing the battery pack 1 from the main body part of the electrical device 201, charging may be performed using an external charger (not shown).

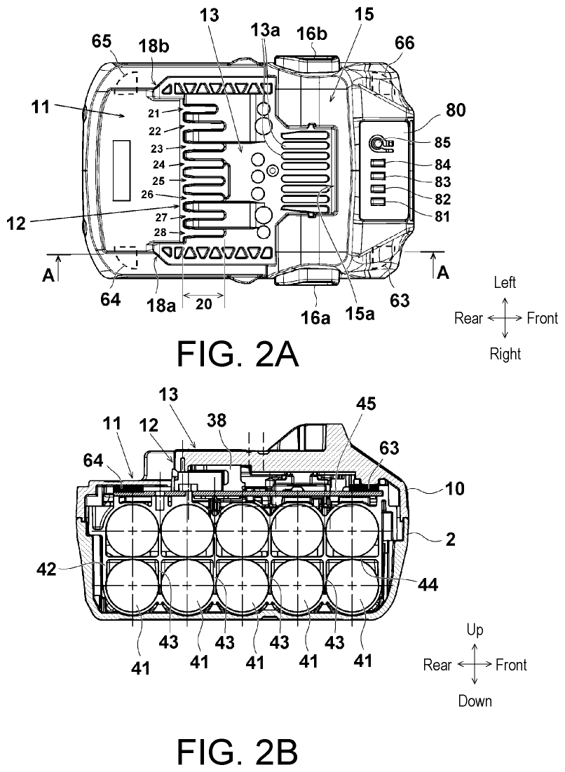

FIG. 2A and FIG. 2B are diagrams showing a battery pack 1 according to an embodiment of the present invention, FIG. 2A is a top view, and FIG. 2B is a cross-sectional view of part A-A. The battery pack 1 has a housing made of synthetic resin composed of an upper case 10 and a lower case 2. The upper case 10 and the lower case 2 are manufactured by integral molding of polycarbonate. A flat lower stage surface 11 is formed on a rear side of the upper case 10, and an upper stage surface 13 formed higher than the lower stage surface 11 is formed in the vicinity of the center. The lower stage surface 11 and the upper stage surface 13 are formed in a step shape, and a connecting portion therebetween forms a step part 12 which is a vertical surface. A rear side portion of the upper stage surface 13 starting from the step part 12 is a slot part arrangement region (slot part) 20. In the arrangement region of the slot part 20, a plurality (herein, eight) of slots 21 to 28, which are notches, are formed at an upper surface parallel to the mounting direction (front-rear direction) and a vertical rear face (step part 12). The slots 21 to 28 are portions that are notched to have a predetermined length in the battery pack mounting direction (front-rear direction) and have a predetermined width in a direction (left-right direction) intersecting the battery pack mounting direction.

A positive electrode terminal (C+ terminal) used for charging of the battery cell is provided in an inner space of the slot 21, and a positive electrode terminal 32 (refer to FIG. 3 for reference sign) for discharging is accommodated in the slot 22. The slot 23 is a spare terminal insertion port, and no terminal is provided in this embodiment. A first signal terminal 34 (T terminal) is accommodated in the slot 24. The T terminal is used for outputting a signal that serves as identification information of the battery pack 1 to the electrical device main body 201 or an external charging device (not shown). A fourth signal terminal (V terminal) 35 is provided at the slot 25 and is used for inputting a control signal from an external charging device (not shown). It is possible that the fourth signal terminal 35 is not used in the case of being mounted to a device other than an external charging device. A second signal terminal (LS terminal) 36 is accommodated in the slot 26 to output temperature information of the battery based on a temperature sensing element (not shown) provided in contact with the battery cell built in the battery pack 1, and perform communication with the main body part of the electrical device 201. A negative electrode terminal 37 is accommodated in the slot 27. A third signal terminal (LD terminal) 38 is accommodated in the slot 28 to output an overdischarge protection signal (abnormality stop signal) based on a main body output control circuit 52 (to be described later with reference to FIG. 3) for battery protection to a connected device (electrical device main body 201 or an external charging device (not shown)).

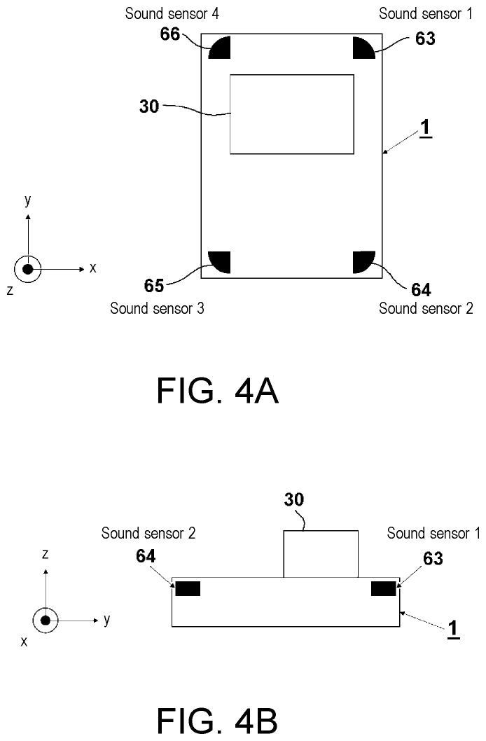

A raised part 15 formed to be raised is formed on a front side of the upper stage surface 13. The raised part 15 has an external shape that is raised higher than the upper stage surface 13, and a stopper part 15a in a recessed shape is formed in the vicinity of its center. The stopper part 15a serves as an abutment surface of the protruding part 214 (refer to FIG. 1) when the battery pack 1 is mounted on the battery pack mounting part 202c. When the protruding part 214 on the main body part side of the electrical device 201 is inserted until abutting against the stopper part 15a, the plurality of terminals (device-side terminals) arranged at the main body part of the electrical device 201 and the plurality of connection terminals (to be described later with reference to FIG. 4A and FIG. 4B) arranged at the battery pack 1 come into contact and become conducted. Further, a plurality of slits 13a serving as cooling air discharge ports are provided at an inner portion of the stopper part 15a.

The latch buttons 16a and 16b are provided at both left and right lateral surfaces of front portions of the rail grooves 18a and 18b. The latch buttons 16a and 16b are spring-biased to be slidable in the left-right direction with respect to the upper case 10 (the spring is not visible in the figure). The locking claws 17a and 17b (refer to FIG. 1) protrude in the left-right direction at the bottom (inside) of the rail grooves 18a and 18b (refer to FIG. 1) due to the action of the spring, and engage with recesses formed at the rail parts 211a and 211b (refer to FIG. 1) of the main body part of the electrical device 201 shown in FIG. 1 to prevent the battery pack 1 from falling off. Upon pushing the latch buttons 16a and 16b respectively inward when the battery pack 1 is mounted on the main body part of the electrical device 201, the locking claws 17a and 17b, which are fixed to and move in conjunction with the latch buttons 16a and 16b, move inward, and the protruding state of the locking claws 17a and 17b from the rail grooves 18a and 18b is released. Once the protruding state is released, by sliding the battery pack 1 in the extending direction of the rail grooves 18a and 18b, it is possible to remove the battery pack 1 from the main body part of the electrical device 201.

A display part 80 is provided on a front slope of the raised part 15. The display part 80 is provided with four display windows 81 to 84, and a push button type switch button 85 is provided on the left side of the display window 81. The switch button 85 is an operation part operated by a user. LEDs (light emitting diodes) are arranged inside the display windows 81 to 84 and are turned on as appropriate. When the switch button 85 is pressed by the user, a remaining battery level is displayed on the display windows 81 to 84 according to the remaining battery level of the battery pack 1. Further, by long-pressing the switch button 85, the switch button 85 functions as a button that instructs another operation to a control part of the battery pack 1.

FIG. 2B is a cross-sectional view along line A-A in FIG. 2A. The lower case (second case) 2 has a substantially rectangular shape with an opened upper surface, and ten battery cells 41 in a cylindrical shape are accommodated in an internal space formed by the upper case 10 and the lower case 2. The ten battery cells 41 are fixed by a separator 42 in a state of being stacked in two stages each including five battery cells 41. The type, size, and quantity of the battery cells 41 are configured in any manner, and herein, the battery cell 41 may be a lithium-ion battery cell capable of multiple-time charging and discharging, with a diameter of 18 mm and a length of 65 mm, or called an 18650 size. Battery sets each composed of five battery cells connected in series are connected in parallel to output a direct current of a rated voltage 18 V. An up-down interval between the battery cells 41 adjacent in the up-down direction is partitioned by an up-down partition wall 44 in a flat plate shape, and a front-rear interval between the battery cells 41 adjacent in the front-rear direction is partitioned by a front-rear partition wall 43 in a flat plate shape, and the adjacent battery cells 41 do not come into contact with each other.

A circuit board 45 is fixed to an upper side of the separator 42. A plurality of connection terminals (only the LD terminal 38 is visible herein) made of metal are fixed (e.g., soldered) to the circuit board 45. The circuit board 45 is formed with a circuit pattern (not shown) to electrically connect a positive electrode side output and a negative electrode side output of the battery cell 41 to a connection terminal group. Furthermore, various electronic components (all not shown herein) such as a battery protection IC, a microcomputer, a storage memory, a PTC thermistor, a resistor, a capacitor, a fuse, a light emitting diode, etc. are mounted on the circuit board 45. In addition to these electronic components, in this embodiment, four sound sensors 63 to 66 are mounted on the circuit board 45. The sound sensors 63 to 66 are one (first sensor) of sensors for collecting sound (sound waves) arriving from outside the battery pack 1. The sound sensors 63 to 66 correspond to a “sensor part” of the present invention.

FIG. 3 is a circuit diagram of the battery pack 1 and the electrical device main body 201. The battery pack 1 is provided with sensors 61 to 69 for sensing, such as an acceleration sensor, and, based on signals from the sensors, a control part 50 outputs physical information inputted from the sensors 61 to 69 directly to the electrical device main body side, or the control part 50 processes the physical information to become easy to use on the electrical device 201 side and outputs the physical information. The battery pack 1 is electrically connected to the electrical device main body 201 via a plurality of connection terminals (32, 34, 36 to 38, etc.). A positive electrode terminal 32 and a negative electrode terminal 37 are power supply terminals connected to a positive electrode and a negative electrode of the battery cell 41 (battery cell set), and are connected to a positive electrode input terminal 232 and a negative electrode input terminal 237 of the electrical device main body 201. The positive electrode side output of the battery cell 41 (battery cell set) is connected to the positive electrode terminal 32, and the negative electrode side output is connected to the negative electrode terminal 37. The battery pack 1 is provided with a positive electrode terminal for charging (so-called C+ terminal) as a power terminal, which is not shown herein.

The battery pack 1 is provided with at least one or more sensors 61 to 69 for sensing which are built-in or externally attached. A conventional battery pack 1 is provided with a sensor for measuring a voltage supplied from the battery cell 41, a sensor for measuring a current, and a sensor for measuring a temperature. The sensors 61 to 69 are not intended to perform detection targeting these internal factors (battery cell 41) of the battery pack 1, but are provided to detect any of physical, optical, electrical, magnetic states, etc., that are attributed to external factors of the battery pack 1. Examples of the sensor 61 to the sensor 69 include an acceleration sensor, a distance sensor (ranging sensor), a light sensor, a human detecting sensor, a position sensor, a sound sensor, an image sensor, and an illuminance sensor, which detect physical information in an environment in which the battery pack 1 is exposed and physical information applied to the battery pack 1 due to an operation on the main body part side of the electrical device 201. Any number of sensors among the sensors 61 to 69 may be provided at the battery pack 1. One of them may be provided or a plurality of them may be provided. Further, like the secondly numbered sensor 62, the sensor may be attached on the outer side in a so-called externally attached state instead of being provided inside the case at the battery pack 1. In that case, to perform electrical wiring between the sensor 62 and the control part 50, a connector for connection may be provided at a position accessible from outside the battery pack 1. Serving the purpose of sensing physical information, each of the sensors 61 to 69 is arranged at a position capable of achieving this purpose and capable of being accommodated in or attached to the battery pack 1.

The control part 50 performs charging and discharging management on the battery cell, and performs control of transmitting, to the electrical device main body 201 side, the physical information acquired by the sensors 61 to 69. The control part 50 corresponds to a “battery pack-side control part” of the present invention. A control power supply circuit 51 converts the power of the battery cell 41 into a low voltage of 3.3 V or 5 V and outputs to the control part 50. The control part 50 is mounted to the circuit board 45 (refer to FIG. 2A and FIG. 2B) and is composed of a microcomputer, a ROM for storing processing programs and control data, a RAM for temporarily storing data, a timer, etc. The outputs inputted from the sensors 61 to 69 is A/D converted by the microcomputer of the control part 50, and are subjected to sampling, noise removal processing, and other necessary processing. The control part 50 is connected with a wireless communication circuit 55. The wireless communication circuit 55 is a circuit for short-range wireless communication such as Bluetooth (registered trademark). The wireless communication circuit 55 is provided with an antenna 56 to enable communication within a distance of several tens of meters.

The control part 50 on the battery pack 1 side is configured to be capable of communicating with the control part 250 on the electrical device main body 201 side, and herein three signal terminals are used. One is second signal terminals (LS terminals) 36 and 236. The LS terminals 36 and 236 are communication terminals for sending an output of a thermistor (temperature sensing element) (not shown) provided for measuring the temperature of the battery cell 41, but are also used as communication terminals for receiving information of the electrical device main body 201 side. First signal terminals (T terminal) 34 and 234 convey a signal that serves as identification information of the battery pack 1 to the electrical device main body 201, but in this embodiment, are also used as communication terminals for transmitting information of the battery pack 1 side via a wired communication circuit 53. The wired communication circuit 53 is a circuit for performing bidirectional wired communication with a battery communication circuit 260 of the electrical device main body 201 using signal terminals including the LS terminal 36 and 236 and the T terminal 34 and 234 which are conventionally used. Furthermore, in this embodiment, third signal terminals (LD terminals) 38 and 238 are communication terminals for outputting, via a main body output control circuit 52, an abnormality stop signal for protecting the battery cell 41 by the control part 50.

The electrical device main body 201 is controlled by the control part 250. The control part 250 corresponds to a “device-side control part” of the present invention. A control power supply circuit 255 is provided for operating the control part 250. The control power supply circuit 255 is a power supply for generating a constant voltage of low voltage (e.g., 3.3 V or 5 V) from a direct current supplied to the positive electrode input terminal 232 and the negative electrode input terminal 237. In the case where the electrical device main body 201 is an impact tool as shown in FIG. 1, when the battery pack 1 is mounted to the main body part of the electrical device 201 and the trigger switch 206 is first pulled, an ON signal of the trigger switch 206 is inputted to the control power supply circuit 255, so the control part 250 starts up. After the control part 250 starts up, a signal for keeping the control power supply circuit 255 in an ON state is continuously outputted by a self-holding circuit 259. A control signal input circuit 261 is a circuit that determines on signals transmitted from the battery pack 1 side via the third signal terminal (LD terminal) 238 and transmits the signals to the control part 250. The battery communication circuit 260 is a circuit for performing bidirectional communication with the control part 50 of the battery pack 1 using the second signal terminal (LS terminal) 236 and the first signal terminal (T terminal) 234.

Although not shown, the control part 250 is composed of a microcomputer for outputting drive signals based on processing programs and data, a ROM for storing processing programs and control data, a RAM for temporarily storing data, a timer, etc. In this embodiment, the motor 204 is composed of a three-phase brushless DC motor and is driven by an inverter circuit 252. The motor 204 is of a so-called inner rotor type and includes a rotor 204a composed of permanent magnets (magnets) including multiple sets (two sets in this embodiment) of N poles and S poles, and a stator 204b composed of star-connected three-phase stator windings U, V, and W. When the trigger switch 206 turns on, signals from three Hall elements 265 are detected by a rotation position detection circuit 266, and the control part 250, which receives the detection signals, calculates the direction and time of energization to the stator windings U, V, and W to control the motor 204 to rotate at a predetermined rotational speed.

The inverter circuit 252 is composed of six switching elements (Q1 to Q6) such as FETs connected in a three-phase bridge configuration. Each gate of the switching elements Q1 to Q6 is connected to an inverter control circuit 251, and each drain or each source of the switching elements Q1 to Q6 is connected to the star-connected stator windings U, V, and W. In this manner, based on the output signal of the Hall element 265 configuring a switch means of the motor 204, the DC power inputted to the inverter circuit 252 is supplied to the stator 204b as three-phase (U phase, V phase, and W phase) voltages Vu, Vv, and Vw by the microcomputer included in the control part 250.

Herein, a PWM signal is supplied to either of the positive power supply-side switching elements Q1 to Q3 and the negative power supply-side switching elements Q4 to Q6 of the inverter circuit 252, and controls the power supplied from the direct current to each stator winding U, V, and W by high-speed switching of the switching elements Q1 to Q3 or the switching elements Q4 to Q6. In this embodiment, since a PWM signal is supplied to the negative power supply-side switching elements Q4 to Q6, it is possible to adjust the power supplied to each stator winding U, V, and W to control the rotational speed of the motor 204 by controlling the pulse width of the PWM signal.

The current value supplied to the motor 204 is measured by a current detection circuit 256 using a shunt resistor 253, and this value is fed back to the control part 250. Further, the voltage value applied to the inverter circuit 252 is inputted to the control part 250 by measuring the voltage across a capacitor 254 for smoothing with a voltage detection circuit 257. An illumination LED 269 is a light emitting device that illuminates a location where an operation is performed with a tip tool. The microcomputer of the control part 250 detects that the operator has operated an illumination button (not shown) provided at the electrical device main body 201, and according to this instruction, the control part 250 turns on or off the illumination LED 269. Further, the control part 250 may notify the operator that the electrical device main body 201 is in a specific state by turning on a mode display LED 268 or the illumination LED 269 in a predetermined lighting mode (flashing, changing display color, etc.) according to communication signals from the microcomputer (control part 50) of the battery pack 1. An operation mode switch 267 is a switch for setting a tightening strength and a tightening mode of the impact tool. The operation mode set by the operation mode switch 267 is displayed by a corresponding mode display LED 268 indicating which operation mode has been selected.

FIG. 4A and FIG. 4B are schematic diagrams showing an example of installing the sound sensors 63 to 66 at the battery pack 1. The sensors 63 to 66 detecting sound serve for collecting sound (sound waves) arriving from outside the battery pack 1, and detect the magnitude of compression waves transmitted through air (medium). Although it is possible to use any of electrodynamic type, electrostatic type, and piezoelectric type microphones as the sensors 63 to 66, herein electrostatic type (condenser) microphones are used. The directions of the X-axis, the Y-axis, and the Z-axis are indicated on the left side of the battery pack 1. The direction indicated by arrows of the X-axis, the Y-axis, and the Z-axis are the positive side. In this manner, using the four sensors 63 to 66, the magnitude of the sound detected by the four sensors 63 to 66 is detected. The four sensors 63 to 66 are provided separately in four directions mainly to detect from which direction the sound arrives on a horizontal plane (a plane passing through the X-axis and the Y-axis).

The communication between the main body part of the electrical device 201 and the battery pack 1 is carried out by a wired communication circuit via the connection terminals 34, 36, 38, etc. for signals, but the communication means may be configured in any manner, and it is also possible to communicate between the main body part of the electrical device 201 and the battery pack 1 by a wireless communication circuit. In this embodiment, by providing a sensor on the battery pack 1 side, it becomes possible for the control part 250 to perform control corresponding to an output signal of the sensor without adding a new sensor on the electrical device main body 201 side. The control of the electrical device main body 201 corresponding to the output signals of the sensors 61 to 69 is performed by increasing/decreasing or stopping the output of the electrical device main body 201 by the control part 250 on the electrical device main body 201 side. The control configuration on the electrical device main body 201 side performed using various sensor signals of the battery pack 1 are as shown in (1) and (2) below. (1) The control part 50 of the battery pack 1 receives a sensor signal, and the main body-side control part 250 controls the electrical device main body 201. (2) Sensor signal processing is performed by the control part 50 of the battery pack 1, and based on its result, the control part 50 of the battery pack 1 controls the main body of the electrical device 201. In this embodiment, control is performed on the electrical device main body 201 side by adopting the procedure of (1).

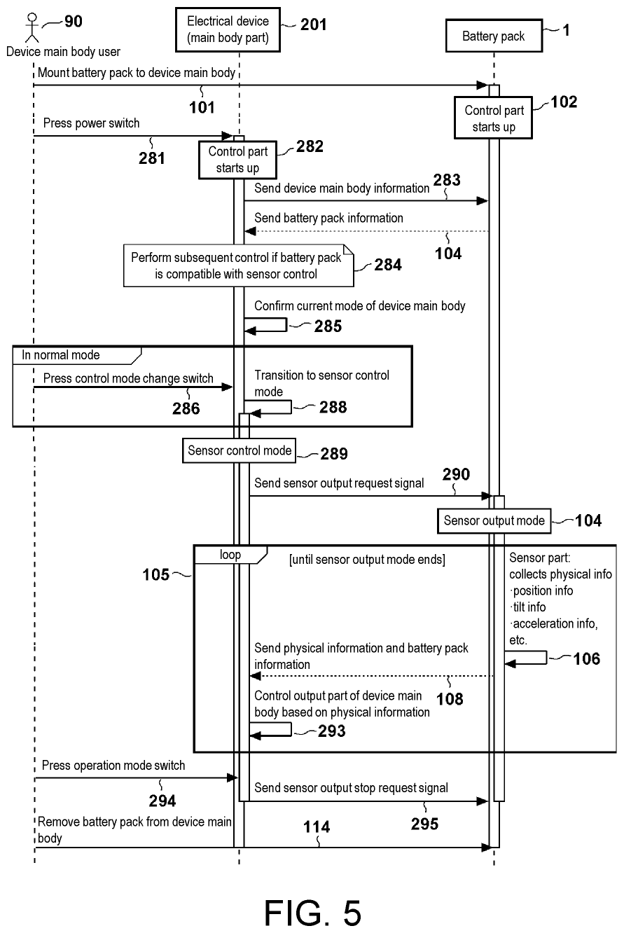

FIG. 5 is a state transition diagram showing an operation procedure of the battery pack 1 and the electrical device main body 201 according to this embodiment. The transition diagram in FIG. 5 starts when the battery pack 1 is mounted to the electrical device main body 201 (step 101). When the battery pack 1 is mounted to the electrical device main body 201, the control part 50 of the battery pack 1 starts up (step 102). Further, with a user 90 pressing the power switch of the electrical device main body 201 (step 281), the control part 250 of the electrical device main body 201 starts up (step 282). In a device (e.g., impact tool) in which a switch dedicated to power supply is not present on the electrical device main body 201, the control part 250 starts up when the trigger switch 206 is first pulled.

Once both the control parts 50 and 250 start up, the control part 250 of the electrical device main body 201 transmits “device main body information” to the control part 50 of the battery pack 1 (step 283). In other words, the battery pack 1 performs communication with the main body part of the electrical device 201. In the communication, a “parameter output of a sensor signal” is performed according to a “sensor output request” from the electrical device main body 201, and the “parameter output of a sensor signal” is stopped by a “sensor output stop request” from the electrical device main body 201 or by release of connection with the electrical device main body 201 (transition from a communicable state to an uncommunicable state). The control part 250 of the electrical device main body 201 transmits the “device main body information” via the second signal terminal 36 and the second signal terminal 236 (step 283). The “device main body information” is composed of the model name of the electrical device main body, information on the electrical device main body necessary for utilizing sensor information, parameters necessary for the control on the electrical device main body, etc. The control part 50 of the battery pack 1 which has received the “device main body information” transmits information on sensors among the sensors 61 to 69 that are mounted to the control part 250 of the electrical device main body 201 (step 104). Next, the control part 250 of the electrical device main body 201 determines whether the mounted battery pack 1 is compatible with sensor control in the electrical device main body 201 (step 284). Herein, if the battery pack 1 is compatible with sensor control, the processing from step 285 onwards is performed, and in the case of being incompatible, the subsequent steps are skipped, and the control part 250 performs control on the electrical device main body 201 in the same manner as in a conventional electrical device main body without using sensor information from the battery pack 1.

Next, the control part 250 of the electrical device main body 201 confirms whether an operation mode currently set by the user 90 is a “sensor control mode” that uses any one or more of the sensors 61 to 69 mounted on the battery pack 1 (step 285). Herein, in the case of not being the “sensor control mode”, the control part 250 remains on standby and does not perform the processing from step 286 onwards. The “sensor control mode” in step 285 is performed by an operation of the user 90 on an “operation mode switch 267” provided at the electrical device main body 201 (step 286). The operation mode switch may be a switch (operation mode switch 267 in FIG. 3) also used for setting a tightening strength and a tightening mode, or may be a new switch provided on an operation panel where various operation switches of the main body part of the electrical device 201 are arranged. With the user 90 pressing this change switch, the control part 250 of the electrical device main body 201 transitions to the “sensor control mode” (step 288). In the case of being also used as the operation mode switch 267, it is possible to transition to the sensor control mode by performing a specific operation such as long-pressing the switch.

The control part 250 of the electrical device main body 201 which has transitioned to the “sensor control mode” (step 289) transmits an “information request signal (sensor output request signal)” to the control part 50 of the battery pack 1 for a sensor output request via the wired communication circuit 53, the second communication terminals 36 and 236, and the battery communication circuit 260 (step 290). The control part 50 of the battery pack 1 which has received the “information request signal (sensor output request signal)” switches to the “sensor output mode” (step 104). In the sensor output mode, the control part 50 collects physical information using a sensor among the sensors 61 to 69 that is mounted and is a target sensor requested for output transmission (step 106). The battery pack 1 shown in FIG. 4A and FIG. 4B has the sound sensors 63 to 66. However, in addition to, or instead of, the sound sensors 63 to 66, physical information may also be collected using a position sensor that detects position information, a posture sensor that detects tilt information, and a three-axis sensor that detects acceleration information. The control part 50 of the battery pack 1 which has collected physical information transmits the physical information together with “battery pack information” to the control part 250 of the electrical device main body 201 (step 108). Herein, the physical information is transmitted to the control part 250 via the wired communication circuit 53, the second communication terminals 36 and 236, and the battery communication circuit 260.

An acquisition timing and a transmission timing of the physical information collected using the sensors 61 to 69 are then executed continuously or intermittently (e.g., each clock time). In this manner, the control part 50 of the battery pack 1 continues to transmit the physical information collected using the sensors 61 to 69 to the electrical device main body 201 side. Thus, the control part 250 of the electrical device main body 201 is capable of performing control on the main body side of the electrical device 201 based on the transmitted physical information, in particular, rotation control on the motor 204, and turning on/off and illuminance control on the mode display LED 268 and the illumination LED 269 (refer to FIG. 3 for both) (step 293).

Steps 106, 108, and 293 enclosed in the box of step 105 continue until the operation mode of the electrical device main body 201 is returned from the “sensor output mode” to a “normal mode” by removal of the battery pack 1 from the main body part of the electrical device 201 or an operation of the user 90 on the operation mode switch 267 provided at the main body part of the electrical device 201 (step 294). When the operation mode switch 267 is operated in step 294, the control part 250 of the electrical device main body 201 transmits an “information request stop signal (sensor output stop request signal)” to the control part 50 of the battery pack 1 (step 295). The “information request stop signal (sensor output stop request signal)” is transmitted in a wired manner from the control part 250 via the battery communication circuit 260, the second signal terminals 236 and 36, and the wired communication circuit 53. After step 295, the control part 250 of the electrical device main body 201 returns to the “normal mode” which does not use sensor outputs from the battery pack 1 side. Finally, by turning off the power switch of the electrical device main body 201 or removing the battery pack 1 from the main body part of the electrical device 201 (step 114), the control as shown in FIG. 5 is ended.

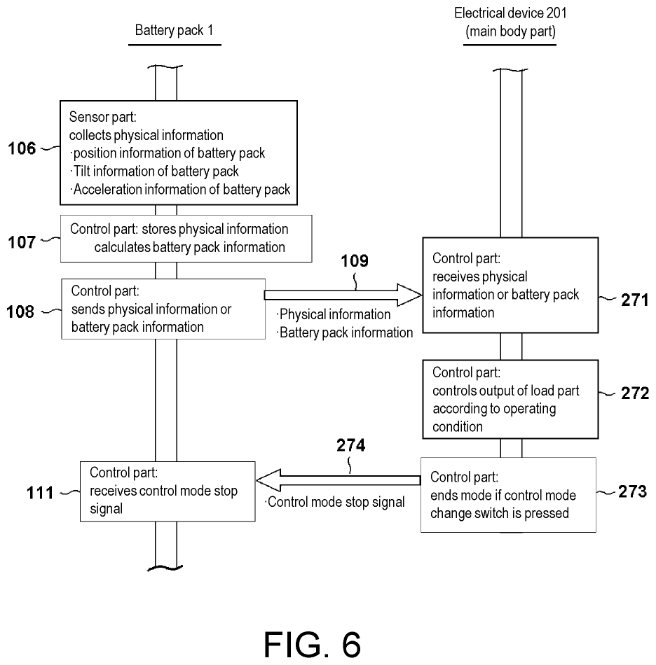

Next, with reference to FIG. 6, a control procedure in the sensor output mode of step 105 in FIG. 5 will be further described. In step 106, the control part 50 of the battery pack 1 performs collection of physical information using the information from the sensors 61 to 69. Herein, examples of the physical information include position information of the battery pack 1, tilt information of the battery pack 1, acceleration information of the battery pack 1, etc. Then, the control part 50 stores the physical information, calculates information on the battery pack 1 based on these pieces of physical information, and transmits the information to the control part 250 of the electrical device main body 201 (steps 107 to 109).

The control part 250 of the electrical device main body 201 controls an output of a load part such as the motor 204 according to the received physical information and battery pack information (steps 271 and 272). This step 272 continues until the sensor output mode is released in step 294 in FIG. 5. Next, when the operation mode switch 267 is pressed, the control part 250 of the electrical device main body 201 ends the sensor output mode (step 273) and transmits a control mode stop signal to the control part 50 of the battery pack 1 (step 274). Upon receiving the control mode stop signal, the control part 50 of the battery pack 1 stops the control mode and transitions to the normal operation mode.

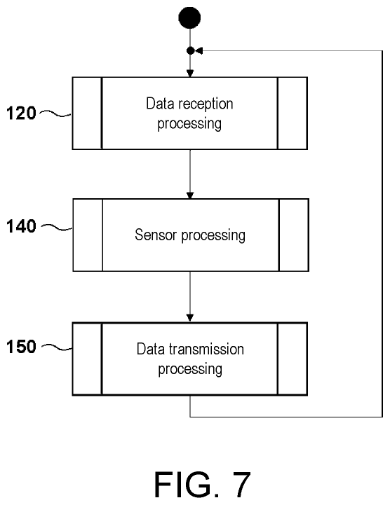

FIG. 7 is a flowchart showing a schematic control procedure in the sensor output mode of the control part 50 of the battery pack 1 shown in FIG. 5. When the operation mode switch 267 of the electrical device main body 201 is pressed and an “information request signal (sensor output request signal)” is transmitted from the electrical device main body 201 (step 290 in FIG. 5), the control part 50 of the battery pack 1 mainly performs control in a loop of data reception processing 120, sensor processing 140, and data transmission processing 150. These controls in a loop continue until the operation mode switch 267 of the electrical device main body 201 is pressed again and an “information request stop signal (sensor output stop request signal)” is transmitted from the electrical device main body 201 (step 295 in FIG. 5).

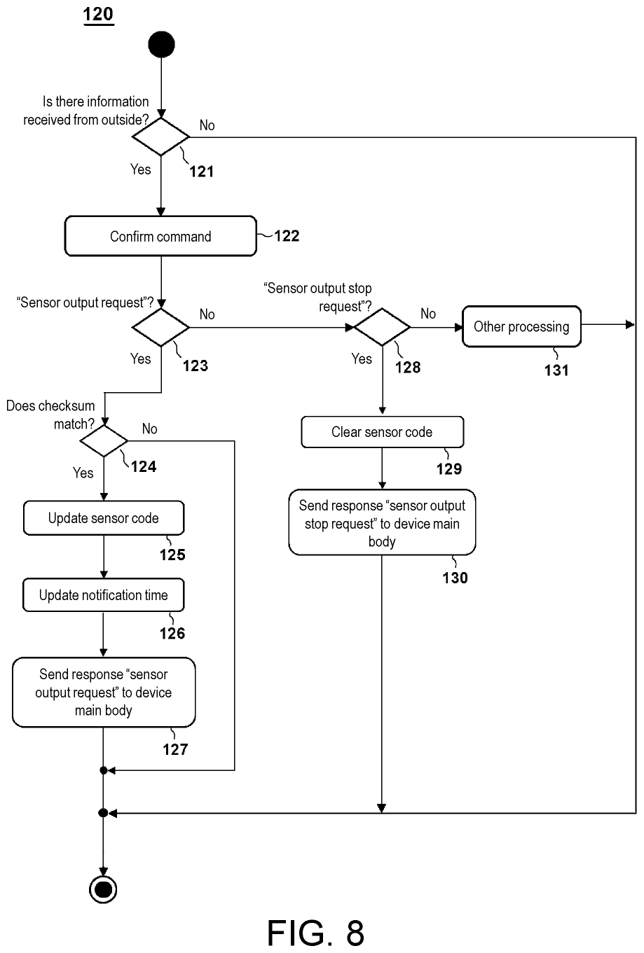

FIG. 8 is a flowchart showing a detailed procedure of the data reception processing 120 in FIG. 7. First, the control part 50 of the battery pack 1 determines whether there has been a reception of communication data from outside (control part 250 of the electrical device main body 201) (step 121). If there has been a reception, the control part 50 performs reception processing of the communication data (confirmation of command) (step 122). A command is prepared at a head of the communication data sent over from the control part 250 of the electrical device main body 201, and the control part 50 of the battery pack 1 and the control part 250 of the electrical device main body 201 identify the communication content by the type of this command. For example, a breakdown of the communication data includes a command indicating a sensor output request at the head, followed by a notification time (time interval for repeating transmission; when the value is zero, no notification is performed over time), a sensor code (designation code indicating any of the sensors 61 to 69 that performs an output), and check data (checksum). The sensor code assigns binary bits to the plurality of sensors in order, assigns 1 to those used and 0 to those not used, and takes, as a code, a decimal notation when viewed as a whole in numbers of a binary notation. For example, if first and third sensors are used among four sensors, it will be “0101” in a binary notation. In response to a command confirmed in this manner, the control part 50 determines whether the content of the command is a “sensor output request” (step 123). Herein, in the case of “Yes”, it is determined whether the checksum of the received data matches a checksum re-created by the control part 50 (step 124), and in the case of matching, the sensor code and the notification time are extracted from the received data and updated and held as sensor data in the control part 50 of the battery pack 1 (step 125). The sensor code is used for power control of the sensor, and the notification time is used for transmitting a “parameter output of a sensor signal” at a constant time cycle in the “data transmission processing” (step 126). Next, the control part 50 of the battery pack 1 transmits a signal in response to the “sensor output request” signal to the electrical device main body 201 (step 127).

In step 123, in the case where the content of the command is “sensor output stop request processing” (step 128), the sensor code is cleared (step 129). Accordingly, the power supply for driving to the sensors 61 to 69 of the battery pack 1 is turned off, and transmission of the “parameter output of a sensor signal” is stopped. Then, the control part 50 transmits a signal in response to the “sensor output stop request” to the electrical device main body 201 (step 130). Further, in step 128, in the case of “No”, other processing is performed and the process returns to step 121 (step 131). The other processing may be, for example, data processing of device main body information sent over by communication, and the information sent over by communication (information received) includes the model name of the electrical device main body, information on the electrical device main body necessary for utilizing sensor information, parameters necessary for control on the electrical device main body, etc.

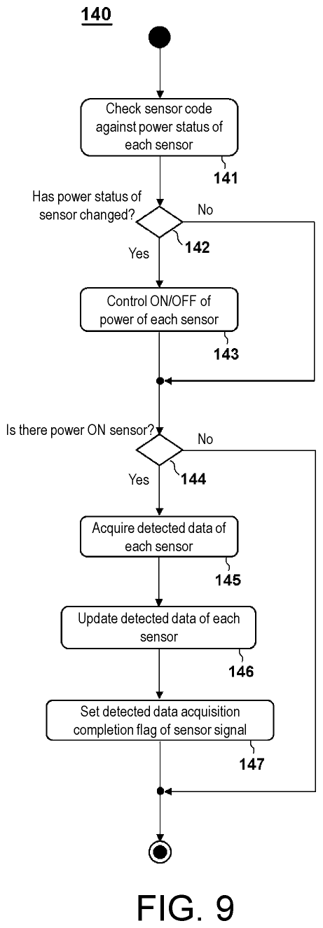

Next, a detailed procedure of the sensor processing 140 in FIG. 7 will be described with reference to FIG. 9. In the sensor processing 140 shown in FIG. 9, based on the sensor code stored in the data reception processing, power management of each sensor is performed and data is acquired from each sensor, which is software-executed by a microcomputer (not shown) included in the control part 50 of the battery pack 1 by executing a computer program. First, the sensor code is checked against the power status of each sensor 61 to 69 (step 141). Next, it is determined whether there has been a change in the power status (operating state due to power supply) of the sensor (step 142). Herein, in the case where there has been a change in the power status of the sensor, the power supply to each sensor 61 to 69 is controlled to be on or off according to the command transmitted from the electrical device main body 201 side (step 143). In the case where there is no change in the power status (operating state due to power supply) of the sensor in step 142, the process proceeds to step 144.

Next, the control part 50 of the battery pack 1 determines whether there is any of the sensors 61 to 69 that is powered on (step 144). Herein, in the case where any of the sensors 61 to 69 is powered on, detection data is acquired from the target sensor (any of 61 to 69) (step 145). The acquired detection data is updated and held as data in the battery pack 1 (step 146). Next, when data acquisition from the necessary sensors 61 to 69 is completed, the control part 50 sets a detection data acquisition completion flag of the sensor signal (step 147). This flag is used for time counting and permission of data transmission in the data transmission processing. In the case where none of the sensors 61 to 69 is powered on in step 144, the process proceeds to a next step of step 147.

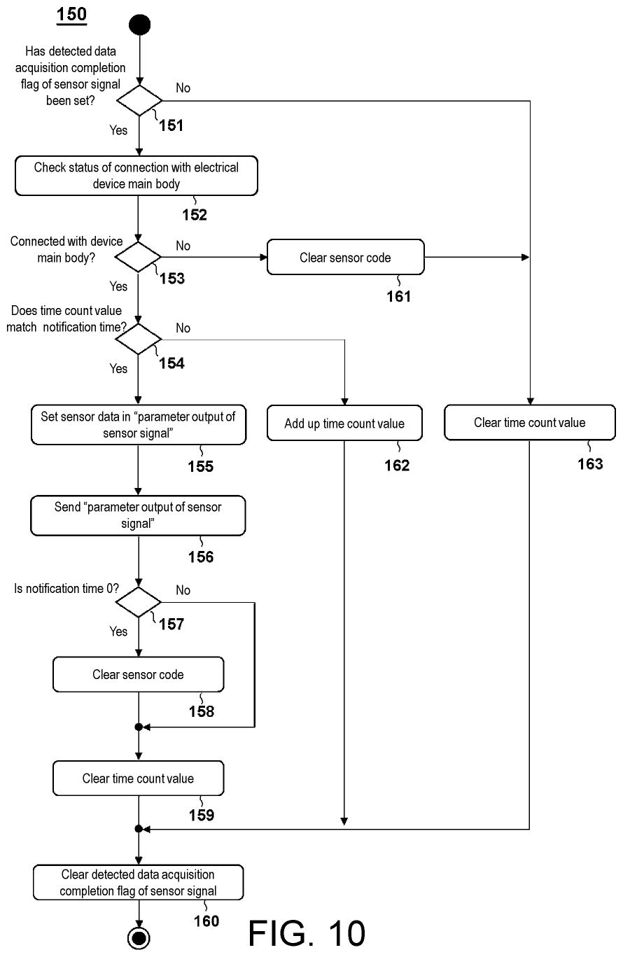

Next, FIG. 10 is a flowchart showing a detailed procedure of the data transmission processing 150 in FIG. 7. In the data transmission processing 150, data transmission is performed each time cycle of the notification time set in the data reception processing. Regarding the time cycle, a time count value is held as data in the battery pack, time is counted, and transmission is performed upon elapse of the notification time, so transmission is performed by the set notification time (the time count value is reset after transmission). Three specific transmission conditions as follows are satisfied. (1) The parameters of the sensor signal have been acquired (detection data acquisition completion flag of the sensor signal is set). (2) It is connected to the device main body (communication is possible). (3) The time count value matches the notification time (if not, the time count value is added up).

First, the control part 50 of the battery pack 1 determines whether the detection data acquisition completion flag of the sensor signal has been set (step 151). Herein, in the case of having been set, the status of connection with the control part 250 of the electrical device main body 201 is confirmed (step 152). In the case of not having been set, the time count value is cleared (step 163), and the process proceeds to step 160. Next, the control part 50 of the battery pack 1 determines whether it is electrically connected to the control part 250 of the electrical device 201 and communication is possible (step 153). In the case of determining in step 153 that it is not connected, the sensor code is cleared (step 161), the time count value is cleared (step 163), and the process proceeds to step 160.

In step 153, in the case of determining that it is connected to the electrical device main body 201, it is determined whether a current time count value being counted matches the notification time (step 154). Herein, in the case where the time count value matches the notification time, the control part 50 sets the detected sensor data in the parameters of the sensor signal (step 155) and transmits to the control part 250 of the electrical device main body 201 (step 156). This communication goes through the path of the wired communication circuit 53, the second signal terminals 36 and 236, and the battery communication circuit 260. Next, the control part 50 determines whether the notification time is zero (step 157), clears the sensor code in the case of zero (step 158), and skips step 158 in the case of not being zero. Next, the control part 50 clears the time count value (step 159) and clears the detection data acquisition completion flag of the sensor signal (step 160). In the case of “No” in step 154, that is, in the case where the time count value does not match the notification time, a predetermined unit is added to the time count value (step 162), and the process proceeds to step 160.

By performing control as described above, the physical information collected from the sensors 61 to 69 provided at the battery pack 1 is inputted to the control part 50 in the battery pack 1, and the sensor signal outputted from the control part 50 is inputted to the control part 250 of the electrical device main body 201 via the communication circuit by wired communication. Thus, the control part 250 is capable of performing various controls using additional sensor signals that are not included in the electrical device main body 201 but are included on the battery pack 1 side. In this configuration, the sensor signal outputted from the battery pack is transmitted by the wired communication circuit (FIG. 3) of the battery pack to the reception (input) terminal via the wired communication circuit of the electrical device main body, and the output control of the electrical device main body is performed by the electrical device main body. By using this configuration, it becomes possible to make fine output adjustments corresponding to the sensor signal. For example, it becomes possible to perform control that cannot be handled by a conventional electrical device alone, such as automatically adjusting the brightness of a light according to the brightness outside.

If the electrical device main body 201 is not compatible with the sensor signal processing of the additional sensors 61 to 69, this embodiment cannot be implemented. Thus, in the case where an electrical device main body that is not compatible with the sensor signal processing is mounted, the control part 50 of the battery pack 1 performs control to stop power supply to the sensors 61 to 69 and not to send out sensor signals to the electrical device main body side. In the case where switching of the control mode using the sensor signal is performed with an operation mode switch provided on the electrical device main body side, the user may also select the normal mode (step 286 in FIG. 5) that does not use the sensor signal, and in that case, the control part 50 stops power supply to the sensors 61 to 69 and does not send out sensor signals to the electrical device main body side.

### Embodiment 2

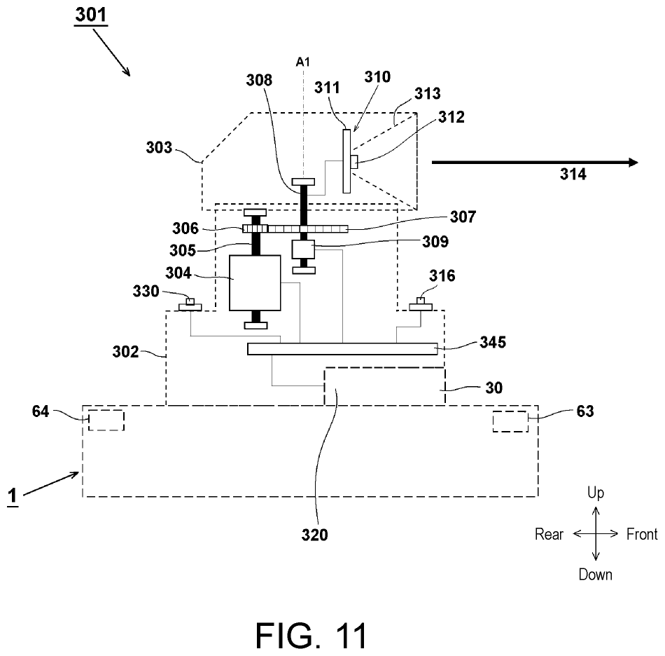

Next, a second embodiment of the present invention will be described with reference to FIG. 11 to FIG. 21. In the second embodiment, a specific device, herein, a lighting device that faces a direction generating sound, will be described as an example of an electrical device main body 301. FIG. 11 is a block diagram showing a configuration of the electrical device main body 301. The electrical device main body 301 is a light that takes a battery pack 1 as a power source and has a mode (sound detection mode) in which an irradiation direction 314 of a light source 312 based on LEDs is controlled by a motor 304 to be directed to a direction in which sound is generated. The electrical device main body (light device main body) 301 includes a light part 303 capable of rotating 360 degrees in the horizontal direction, and a light source 312 is provided in one direction of the light part 303. An irradiation part 310 includes LEDs (light emitting diodes) serving as the light source 312 mounted on a substrate 311, and has a reflector 313 that guides a light emission direction in one direction. The light part 303 is axially supported by a drive shaft 308 at a central axis (=rotation axis) A1 and is held to be rotatable in a horizontal plane with respect to a main housing 302.

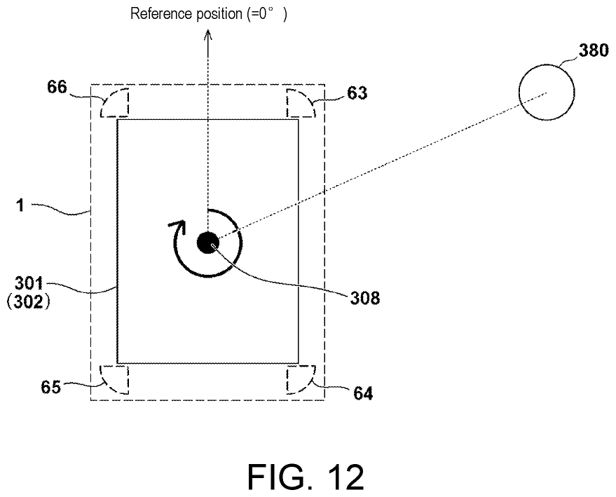

The light part 303 has the same structure as a conventional light device in terms of its function as a lighting device, except that it is rotatable around the central axis A1. The battery pack 1 is the same as the battery pack 1 shown in the first embodiment, has a connection terminal part 30, and has a plurality (herein, four) of sound sensors 63 to 66 (refer to FIG. 12 to be described later for reference signs 65 and 66) as sensors that collect physical information.

The electrical device main body 301 has a mounting part to which the battery pack 1 is mounted, and a connection terminal part 320 is provided at the mounting part. By fitting the connection terminal part 30 and the connection terminal part 320, the power of the battery pack 1 is supplied to a control circuit board 345 of the electrical device main body 301. The main housing 302 of the electrical device main body 301 is provided with a power switch 330 for turning on the light source 312 and an operation mode switch 316 for setting whether to rotate the light part 303 to follow the direction facing sound. The switching by the power switch 330 and the operation mode switch 316 is detected by a control circuit (specifically, a microcomputer (not shown)) mounted on the control circuit board 345, and by turning on or off the power supply to the light source 312 or supplying power to the motor 304, the light part 303 is rotated.

The motor 304 is a drive source for rotating the drive shaft 308 which axially supports the light part 303, and a rotation shaft 305 is arranged to face a vertical direction. A first gear 306 composed of a spur gear is provided at the rotation shaft 305. A lower end side of the drive shaft 308 is rotatably and axially supported at the main housing 302, and the other end is fixed to the light part 303 in a manner not capable of rotating. A second gear 307 composed of a large spur gear is fixed to the drive shaft 308, and with the first gear 306 and the second gear 307 meshing with each other, the rotational force of the motor 304 is transmitted to the drive shaft 308 in a decelerated state. A slip ring 309 is provided below the second gear 307 on the drive shaft 308 to enable power supply from the control circuit board 345 to the light source 312 of the rotating light part 303. Although not shown herein, the mounted motor 304 has a position detection means (not shown) capable of detecting its rotation angle, or has a configuration that allows the microcomputer to determine the rotation position of the drive shaft 308. The switching of the mode is capable of changing by pressing the operation mode switch 316, and includes a “normal mode” that keeps the light part 303 in a fixed state without rotating by the motor 304, and a “sound detection mode” that rotates the light part 303 to face the direction where sound arrives using the motor 304. This switching of the mode may also be configured to be changed by transmitting a “control mode change request” from an external device such as a smartphone via the wireless communication circuit 55 of the battery pack 1.

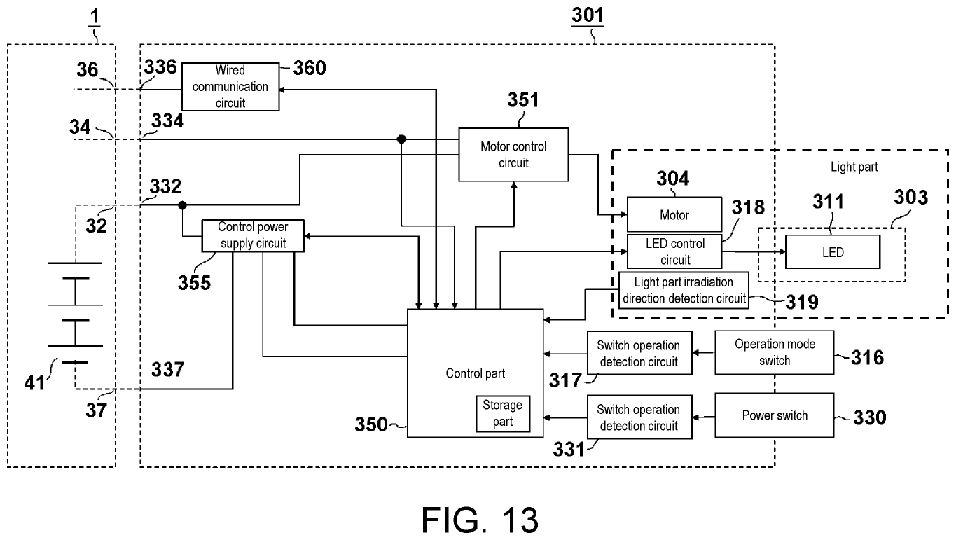

FIG. 12 is a top view for describing an operation of the light part 303 (refer to FIG. 11) of the electrical device main body 301. Four sound sensors 63 to 66 are provided at four corners near an upper surface of the battery pack 1. The sensors 63 to 66 correspond to the “sensor part” of the present invention. The main housing 302 of the electrical device main body 301 does not rotate with respect to the battery pack 1. The drive shaft 308 protruding upward from inside is extended at the main housing 302. The drive shaft 308 is rotatable by the motor 304 (refer to FIG. 11), and the light part 303 (refer to FIG. 11) fixed to the upper part of the drive shaft 308 rotates. Herein, taking the front direction of the battery pack 1 as a reference position (rotation angle 0 degrees), a rotation direction 381 is a clockwise direction in FIG. 12. A control part 350 (refer to FIG. 13 to be described later) of the electrical device main body 301 performs data processing of the sound collected from the four sound sensors 63 to 66 when in the sound detection mode, and upon detection of arrival of sound from a specific direction, the control part 350 is capable of performing control to direct the irradiation direction 314 (refer to FIG. 11) of light towards an estimated position 380 of the sound source by driving the motor 304. By performing control in this manner, it is possible to realize a light device capable of irradiating light following an operation spot when an operator performs an operation while moving at the operation site or the like.

FIG. 13 is a block diagram showing a circuit configuration of the electrical device main body 301. The basic configuration is the same as the configuration shown in FIG. 3. Herein, since the electrical device main body 301 is a light device, the configuration of the light part 303 has been newly added. Further, an LED control circuit 318 for turning on the LED 312 of the light part 303 and a motor 304 for rotating the light part 303 are added. Furthermore, a light part irradiation direction detection circuit 319 that detects an orientation of the irradiation direction (rotation angle in degrees with respect to the reference angle 0 degrees in FIG. 12) is provided at the light part 303. The battery pack 1 which supplies power to turn on the LED 312 and rotate motor 304 has the same configuration as in the first embodiment shown in FIG. 3. The battery pack 1 is provided with a first signal terminal 34 and a second signal terminal 36 as input parts, and is also provided with a positive electrode terminal 32 and a negative electrode terminal 37. Other configurations and other connection terminals (C+ terminal 31 and third signal terminal 38) of the battery pack 1 are not shown.

The entirety of the electrical device main body 301 is controlled by the control part 350, which operates on a reference power supply supplied from the control power supply circuit 355. The control part 350 performs rotation control on the motor 304, receives the outputs of various sensors (herein, the sound sensors 63 to 66) from the control part 50 side of the battery pack 1 via the wired communication circuit 360, and processes the received signals to control the rotation of the motor 304 and control the irradiation direction by the light part 303 according to the processing results. The control part 350 corresponds to the “device-side control part” of the present invention. The motor 304 is driven by a motor control circuit 351 according to the control of the control part 350. The motor 304 and the motor control circuit 351 used herein may be set in any manner, and for example, it is possible to perform control using a stepping motor. The LED control circuit 318 which performs turn-on of the light source 312 of the light part 303 is controlled by the control part 350. The light part irradiation direction detection circuit 319 is configured using a conventional position detection means and outputs a signal indicating the rotation angle to the control part 350. A microcomputer (not shown) of the control part 350 performs rotation control on the motor 304 using signals detected from the light part irradiation direction detection circuit 319 and the physical information based on the sensors received from the battery pack 1. A switch operation detection circuit 317 detects on/off of the operation mode switch 316 and outputs to the control part 350. A switch operation detection circuit 331 detects on/off of the power switch 330 and outputs to the control part 350.

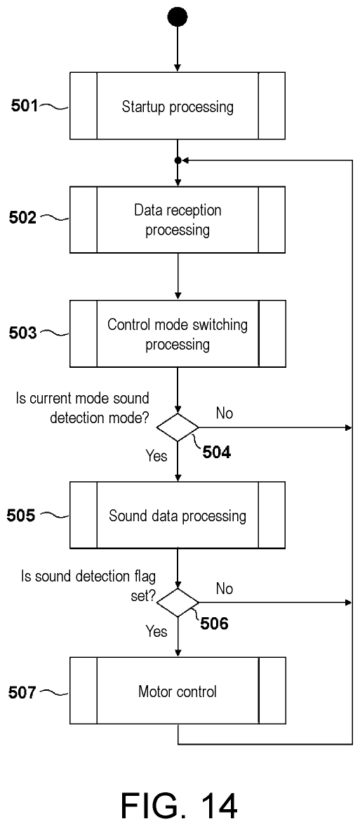

FIG. 14 is a flowchart showing a schematic control procedure in the control part 350 of the electrical device main body 301 according to the second embodiment. The control related to the sensor output in the electrical device main body 301 is performed according to the procedure shown in FIG. 14. First, with the power switch 330 of the electrical device main body 301 turning on, the control part 350 starts up. At this time, the control part 350 performs startup processing (step 501). Next, the control part 350 performs reception processing of receiving physical information (herein, “sound data”) acquired by the sensors 63 to 66 from the battery pack 1 (step 502). Further, it is determined whether the operation mode switch 316 of the electrical device main body 301 has been pressed, and switching processing of the control mode is performed (step 503). Herein, in the case where the current mode is the “sound detection mode”, the process proceeds to step 505, and in the case of not being the “sound detection mode”, the process returns to step 502 (step 504).

In step 504, in the case where the current mode is the “sound detection mode”, the control part 350 performs processing of the sensor information (herein, sound data) transmitted from the battery pack 1 (step 505). Next, the control part 350 determines whether a “sound detection flag” has been set (step 506), in the case of having been set, the control part 350 executes control on the motor (step 507), and in the case of not having been set, the control part 350 returns from step 506 to step 502. In this manner, the control part 350 of the electrical device main body 301 performs control in a loop of the data reception processing 502, the control mode switching processing 503 of sensor processing, the sound data processing 505 (if in the sound detection mode), and the motor control 507 (if sound is detected), and the processing in FIG. 14 is repeated until the power switch 330 (refer to FIG. 11) turns off.

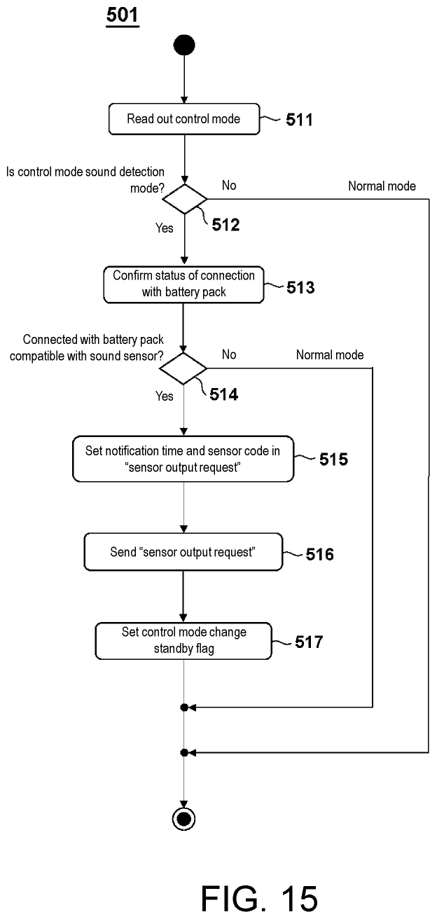

FIG. 15 is a flowchart showing a detailed procedure of the startup processing 501 in FIG. 14. First, the control part 350 of the electrical device main body 301 reads out a status flag of the set control mode from a built-in storage part (not shown) at startup (step 511), and determines whether the status flag is the “sound detection mode” (step 512). Herein, in the case of the “sound detection mode”, “sensor output request processing” over subsequent steps 513 to 517 is performed. In the case where the control mode is not the sound detection mode in step 511, the control part 350 controls the operation of the electrical device main body 301 in the “normal mode”.

In the “sensor output request processing”, first, the status of connection with the battery pack 1 is confirmed (step 513). Herein, in the case of being connected to a battery pack 1 compatible with a sound sensor (“Yes” in step 514), a notification time and a sensor code are set in a “sensor output request” (step 515), the “sensor output request” is transmitted to the battery pack 1 (step 516), and a control mode change standby flag is set (step 517). The control mode change standby flag is a flag for checking whether the “sensor output request” or the “sensor output stop request” has arrived at the battery pack 1, and resets when a response arrives. However, in step 514, if the battery pack 1 is not compatible with a sound sensor, no request is made, so in that case, the electrical device main body 301 is used only in the normal mode.

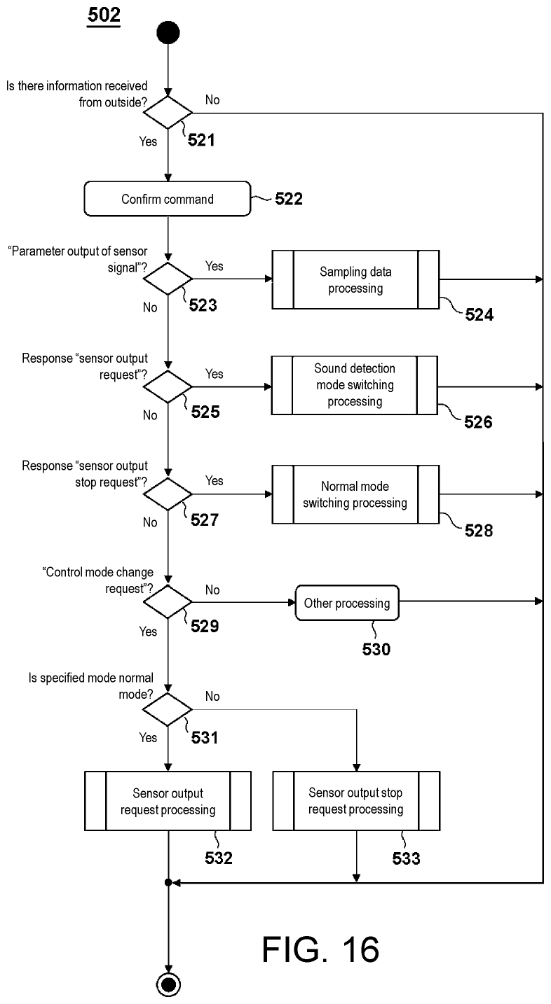

FIG. 16 is a flowchart showing a detailed procedure of the data reception processing 502 in FIG. 14. First, the control part 350 of the electrical device main body 301 determines whether there is reception of data from outside (battery pack 1) (step 521). If there is no reception of data, the entire processing in FIG. 16 is skipped. In the case where there is a reception of data from the battery pack 1, a command sent over is confirmed to identify the communication content (step 522). The control part 350 of the electrical device main body 301 determines whether the received command is a parameter output of a sensor signal (step 523). In the case of “Yes” in step 523, the control part 350 of the electrical device main body 301 performs “sampling data processing” (step 524). In the “sampling data processing”, the control part 350 of the electrical device main body 301 confirms the received data, determines whether the checksum matches, and in the case where the checksum matches, holds the data obtained from the sound sensor as sampling data in the electrical device main body 301 by updating the sampling data. The sampling data is held for a given past period.

In the case of “No” in step 523, it is determined whether the received command is a response to a sensor output request (step 525). Herein, in the case of “Yes”, “sound detection mode switching processing” is performed (step 526). In the sound detection mode, the control part 350 of the electrical device main body 301 performs processing of changing the control mode, clearing a standby flag, clearing a standby time count, clearing a retransmission counter, switching the control mode to the sound detection mode to save the control mode, and clearing the sampling data. The standby time count is a value for counting a given time for performing communication (transmission) again in the case where a target response does not come even after the given time elapses.

In the case of “No” in step 525, it is determined whether the received command is a response to a sensor output stop request (step 527). Herein, in the case of “Yes”, “normal mode switching processing” is performed (step 528). In the normal mode switching processing, the control part 350 of the electrical device main body 301 changes the control mode, clears the standby flag, clears the standby time count, clears the retransmission count, switches the control mode to the normal mode, and saves the control mode.

In the case of “No” in step 527, it is determined whether the received command is a control mode change request (step 529). Herein, in the case of “No”, “other processing” is performed. The other processing is, for example, data processing of electrical device main body information sent over by communication, and the information sent over (received information) includes the model name of the electrical device main body, information on the electrical device main body necessary for utilizing sensor information, parameters necessary for the control on the electrical device main body, etc.

In the case of “Yes” in step 529, it is determined whether the specified mode is the normal mode (step 531). In the case of the normal mode, “sensor output request processing” is performed (step 532). In the “sensor output request processing”, the control part 350 of the electrical device main body 301 executes the same processing as steps 513 to 517 in FIG. 15. In the case of “No” in step 531, “sensor output stop request processing” is performed (step 533). In the sensor output stop request processing, the control part 350 of the electrical device main body 301 transmits a sensor output stop request and sets a control mode change standby flag.

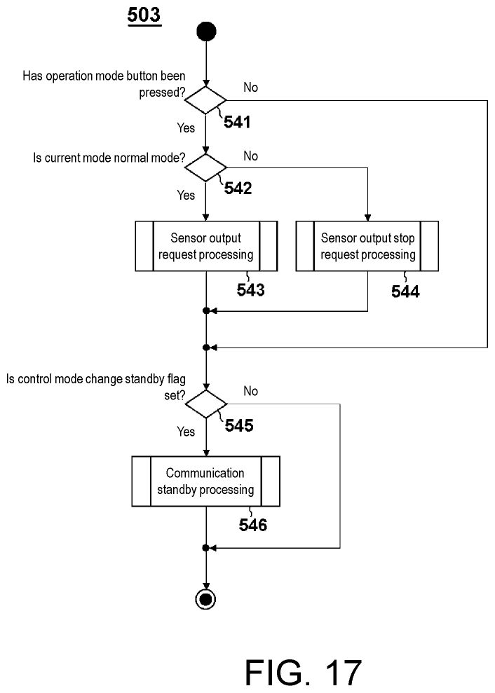

FIG. 17 is a flowchart showing a processing procedure in the case where the operation mode switch 316 is pressed by the user. In the control mode switching processing, a control mode change is performed in the case where the operation mode switch 316 is pressed, and first, the control part 350 of the electrical device main body 301 determines whether the operation mode switch 316 has been pressed (step 541). In the case of “No” in step 541, the process proceeds to step 545. In the case of “Yes” in step 541, it is determined whether the current mode is the normal mode (step 542).

In the case of “Yes” in step 542, that is, in the case of the normal mode, the sensor output request processing is performed for the battery pack 1 (step 543). In sensor output request processing, the control part 350 of the electrical device main body 301 executes the same processing as steps 513 to 517 in FIG. 15. In the case of “No” in step 542, that is, in the case of not being the normal mode, “sensor output stop request processing” is performed (step 544). The sensor output stop request processing is the same as step 533 in FIG. 16, and the control part 350 of the electrical device main body 301 transmits a sensor output stop request and sets a control mode change standby flag.

Next, in step 545, it is determined whether the control mode change standby flag has been set (step 545). In the case of “Yes” in step 545, that is, in the case where the control mode change standby flag has been set, “communication standby processing” is performed (step 546). In the case of “No” in step 545, step 546 is skipped.

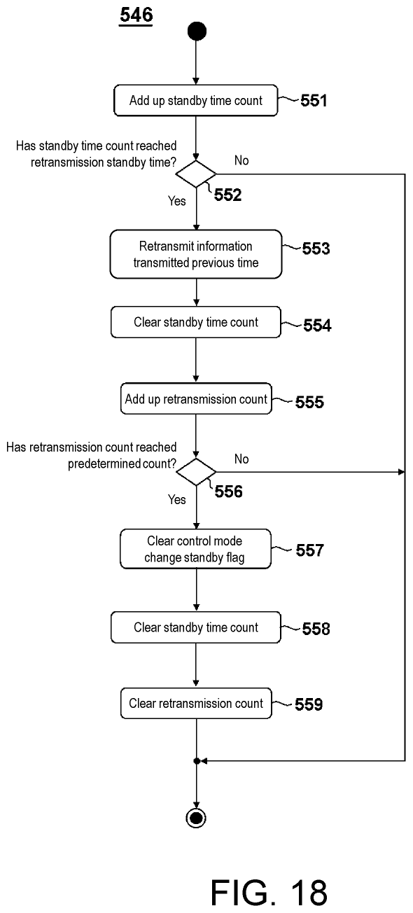

FIG. 18 is a flowchart showing a detailed procedure of the communication standby processing 546 in FIG. 17. In the “communication standby processing”, processing is performed during a period until a response from the battery pack 1 arrives at the control part 350 of the electrical device main body 301. If there is no response for a given time, the sensor output request is retransmitted to the battery pack 1, and if there is no response even after retransmitting the sensor output request for a predetermined number of times, the transmission is stopped. First, the control part 350 of the electrical device main body 301 adds up a standby time count (step 551). Then, the control part 350 determines whether the standby time count has reached a retransmission standby time (step 552). In the case of not having reached the retransmission standby time in step 552, the processing in FIG. 18 is ended, and in the case of having reached the retransmission standby time, the information transmitted previous time is retransmitted to the battery pack 1 (step 553). Then, the control part 350 clears the standby time count (step 554) and adds up the retransmission count (step 555). Then, the control part 350 determines whether the retransmission count has reached a predetermined count, and in the case of not having reached the predetermined count, the control part 350 ends the processing in FIG. 18, and in the case of having reached the predetermined count, the control part 350 clears the control mode change standby flag, the standby time count, and the retransmission count and ends the processing in FIG. 18 (steps 557 to 559).

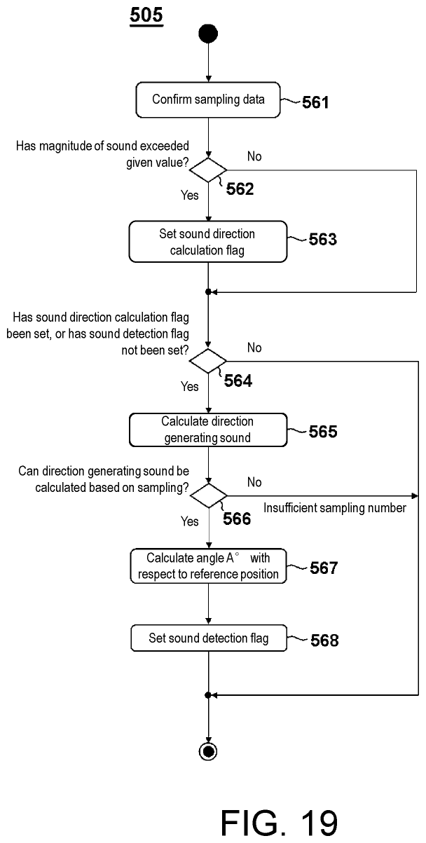

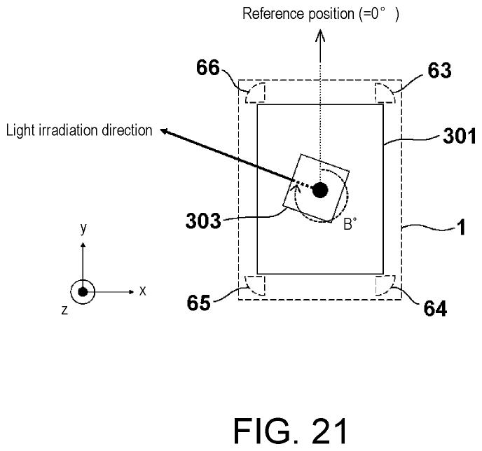

FIG. 19 is a flowchart showing a detailed procedure of the sound data processing 505 in FIG. 14. In the sound data processing 505, first, the control part 350 confirms the sampling data received from the battery pack 1 (step 561), and confirms whether the magnitude of the sound has exceeded a given value (step 562). In the case where the magnitude of the sound has exceeded the given value, the control part 350 sets a sound direction calculation flag (step 563), and in the case of not having exceeded the given value, the process skips to step 564. Then, the control part 350 determines whether the sound direction calculation flag has been set or whether the sound detection flag remains unset (step 564). In the case of “Yes” in step 564, using the physical information from the four sound sensors 61 to 64, the control part 350 estimates the direction of the sound by calculation based on past sound data and subsequent sound data (step 565). Herein, it is determined whether it is possible to estimate the direction of sound (step 566), and if estimation is possible, the direction of sound is calculated as an angle A (refer to FIG. 21 to be described later) from the reference position (step 567). Then, the control part 350 sets a sound detection flag (step 568) and ends the processing in FIG. 19. In the case where it is not possible to estimate the direction of sound in step 566, for example, in cases such as insufficient sampling of sound data, the processing in FIG. 19 is ended.

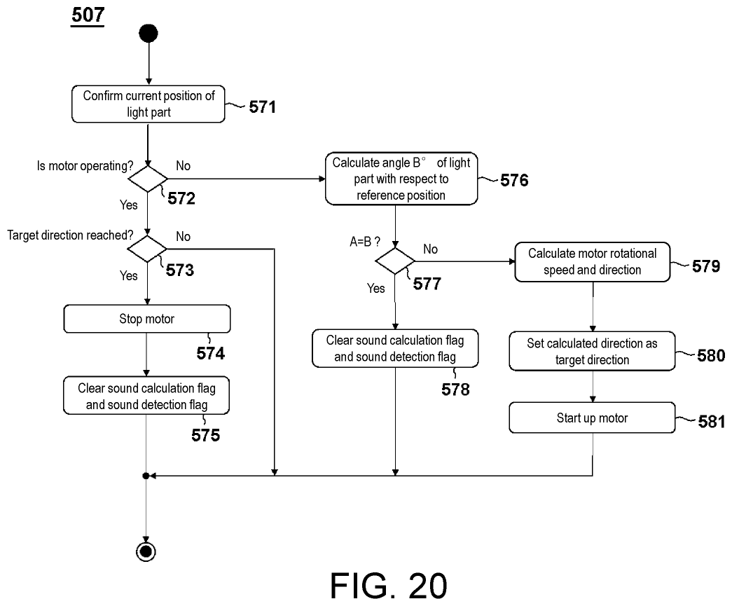

FIG. 20 is a flowchart showing a detailed procedure of the motor control 507 in FIG. 14. In the motor control 507, the control of directing the light part 303 to the direction of the sound source is performed by driving the motor 304 to the direction confirmed in the sound data processing 505. First, the control part 350 of the electrical device main body 301 confirms the current direction in which the light part 303 is facing (step 571). Then, the control part 350 determines whether the motor 304 is operating (step 572). Herein, in the case where the motor 304 is operating (in the case where the motor 304 is operating), it is determined whether the irradiation direction of the light part 303 is facing the sound source direction, that is, whether the arrival direction of light has reached the target direction (sound source direction) (step 573). In the case of being in the sound source direction in step 573, rotation of the motor 304 is stopped (step 574), the sound direction calculation flag and the sound detection flag are cleared, and the processing in FIG. 20 is ended (step 575). Further, in step 573, in the case where the irradiation direction of the light part 303 has not reached the target direction, the processing in FIG. 20 is ended, and the process returns to step 506 in FIG. 14. The sound direction calculation flag is a flag set up when exceeding a threshold (magnitude of sound) for determining that a sound has been generated, and is used for entering the flow of calculating the direction of sound. The sound detection flag is a flag set up when estimation of the direction generating sound is completed, and is used for entering a motor operation flow.

In step 572, in the case where the motor is not operating (in the case where the motor 304 is not operating), the control part 350 calculates a rotation angle B° from the reference position of the light part 303 (step 576). Then, the control part 350 determines whether the angle A (°) of the estimated position of the sound source is equal to the rotation angle B (°) (step 577), and in the case of A=B, clears the sound calculation flag and the sound detection flag, and ends the processing in FIG. 20 (step 578). In step 577, in the case of A≠B, the control part 350 calculates the motor rotational speed and the direction of the sound source (step 579), sets the calculated direction as the target direction (step 580), starts up the motor 304 (step 581), and returns to step 506 in FIG. 14.

FIG. 21 is a top view for describing a change in the irradiation angle of the electrical device main body 301 in FIG. 11. By performing the controls in FIG. 14 to FIG. 20 using the outputs of the four sound sensors 63 to 66 mounted at the battery pack 1, the control part 350 directs the light to a direction obtained by rotating the rotation angle of the light part 303 by B° clockwise from the reference position (0 degrees). At a timing of switching to the sound detection mode, a “sensor output request (information request signal and sensor output request signal)” is transmitted to the battery pack 1, and the control part 350 performs rotation control on the motor 304 according to the “parameter output of a sensor signal (physical information/battery pack information, or operating conditions)” returned from the battery pack 1. Upon switching from the sound detection mode to the normal mode, the irradiation direction is fixed to the irradiation direction at the time of switching or returns to the initial position.

### Embodiment 3

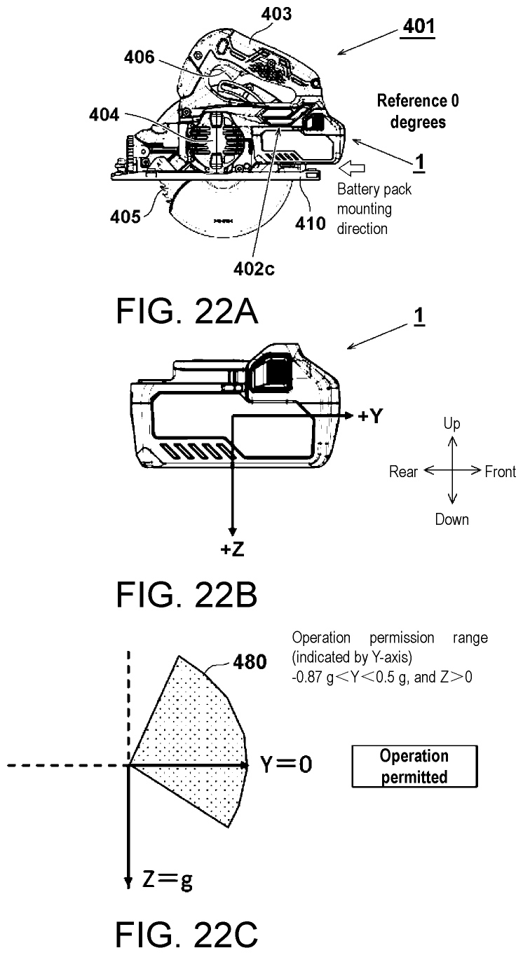

Next, regarding a configuration using an acceleration sensor as the sensor part, a specific control method in the case where an electrical device main body 401 is a circular saw will be described with reference to FIG. 22A to FIG. 24C. FIG. 22A is a left side view of the electrical device main body 401, and FIG. 22B is the posture of the battery pack 1 when in the state of FIG. 22A. The directions of the Y-axis and the Z-axis shown in FIG. 22B are directions based on the battery pack 1. The battery pack 1 is capable of being mounted to a battery pack mounting part 402c by relatively moving in a direction indicated by an arrow from the rear to the front side with respect to the electrical device main body 401. In other words, in FIG. 22A to FIG. 24C, the mounting direction of the battery pack 1 with respect to the electrical device main body 401 becomes the forward direction (−Y-axis direction). The information on the electrical device main body 401 includes the mounting direction of the battery pack 1. The acceleration sensor provided at the battery pack 1 may be one sensor, and in this embodiment, is provided at the position of the sensor 64 in FIG. 2A and FIG. 2B. The electrical device main body 401 includes a base 410 that is placed and slides on a cut object, a saw blade 405 that protrudes from an opening provided at the base 410 to the lower surface of the base, a motor 404 that rotates the saw blade, and a handle part 403 that is provided at an upper part of a housing accommodating the motor 404. A trigger lever 406 for turning on rotation of the motor 404 is provided at the handle part 403. Since the configuration of the electrical device main body 401 is conventionally known, detailed descriptions thereof will be omitted.

Since the battery pack 1 is mounted to the electrical device main body in a horizontal state, when the electrical device main body 401 is in the horizontal state as in FIG. 22A, the battery pack 1 is also in the horizontal state. When a cutting operation is performed with the circular saw in this horizontal state, in the output of the acceleration sensor 64 (refer to FIG. 2A and FIG. 2B) of the battery pack 1, Z, which is a gravitational component in the +Z direction as shown in FIG. 22B, is detected as 1 g (g is gravitational acceleration, and 1 g=9.80665 m/s²). Accordingly, it is possible to detect the tilt of the battery pack 1 by the acceleration sensor 64 (refer to FIG. 2A and FIG. 2B).

The electrical device main body (circular saw) 401 is configured to be capable of changing a protrusion amount (so-called cutting depth) of the saw blade protruding from below the base 410 with respect to the base 410. That is, an angle of an electrical device main body with respect to the base 410 is configured to be changeable. The state in which the protrusion amount of the saw blade from the base 410 is maximum is the state in FIG. 22A. On the other hand, in the state in which the protrusion amount of the saw blade from the base 410 is minimum, the electrical device main body is in a state within an operation permission range 480 (an example of identification information) in FIG. 22C. Thus, within a range in which the cutting depth can be adjusted, the electrical device main body 401 is in a state within the operation permission range 480 and is capable of performing the cutting operation.

In the case where a reference direction of the Y-axis of the acceleration sensor 64 mounted to the battery pack 1, which changes according to the operating posture of the electrical device main body, is within the operation permission range 480 shown in FIG. 22C, the control part 50 of the battery pack 1 permits the operation of the electrical device main body 401. Herein, whether it is “within the operation permission range 480” may be determined according to the sizes of the Y component and the Z component in the output of the acceleration sensor 64, and is determined to be within the operation permission range in the case where −0.87 g<Y<0.5 g and Z>0. In the diagram of FIG. 22C, the horizontal axis dotted line is an absolute Y-axis direction (one direction passing through a horizontal plane), and the vertical axis dotted line is an absolute Z-axis direction (one direction passing through an extending plane). In the posture in a stationary state of the electrical device main body 401 in FIG. 22A, due to gravitational acceleration, Y=0 and Z=+g, which falls within the range of the operation permission range 480 described above. The control part 50 of the battery pack 1 outputs information (physical information including the posture and orientation of the electrical device main body) inputted from the acceleration sensor 64 or battery pack information (battery pack information related to physical information) that allows operation of the electrical device main body 401 based on the information to a control part 450 (corresponding to the control part 250 in FIG. 3 and the control part 350 in FIG. 13) of the electrical device main body 401. The operator may continue the operation with the electrical device main body 401 thereafter.

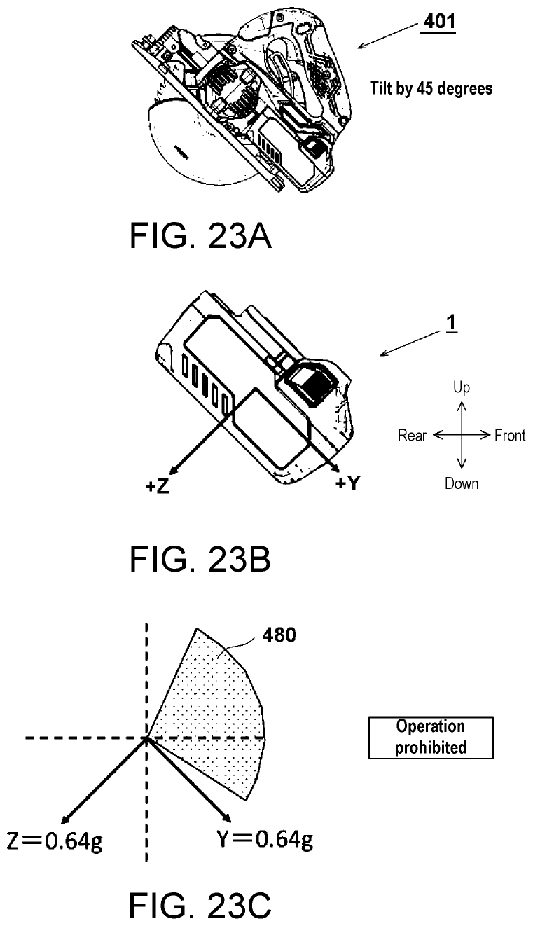

FIG. 23A to FIG. 23C are a state in which the posture of the front side of the electrical device main body 401 is tilted upward by about 45 degrees from the state in FIG. 22A, FIG. 23A is a left side view of the electrical device main body 401 (circular saw main body), and FIG. 23B is the posture of the battery pack 1 when the electrical device main body 401 is in the state of FIG. 23A. As can be clearly seen in comparison with the state in FIG. 22A to FIG. 22C, since the battery pack 1 in the case of this posture becomes the same posture as shown in FIG. 23B together with the electrical device main body 401, due to the influence of gravitational acceleration, the detection values of the acceleration sensor 64 become 0.64 g in the Z-axis direction and 0.64 g in the Y-axis direction as shown in FIG. 23C. This falls outside the range of the operation permission range 480 described above. The control part 50 of the battery pack 1 outputs this posture information (physical information including the posture and orientation of the electrical device main body) or the battery pack information (battery pack information related to the physical information, e.g., a stop signal) that prohibits the operation of the electrical device main body 401 based on this posture information to the control part 450 (not shown) of the electrical device main body 401. As a result, the operation with the electrical device main body 401 is prohibited (stopped).

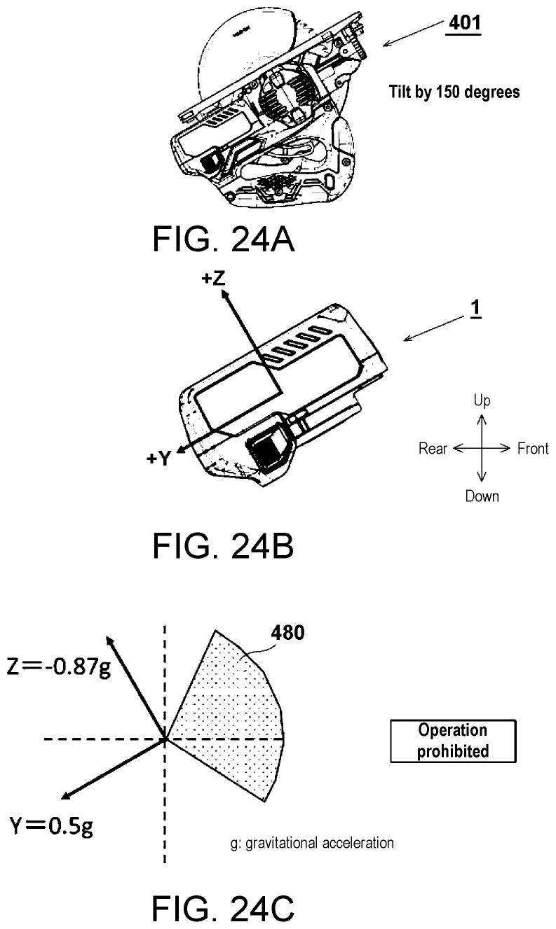

FIG. 24A to FIG. 24C are a state in which the posture of the electrical device main body 401 has inverted and rotated by about 150 degrees from the state in FIG. 22A. This state corresponds to an operation state in which the operator uses the circular saw to cut branches of trees or to cut wood on the ceiling from below. FIG. 24A is a left side view of the electrical device main body 401, and FIG. 24B is the posture of the battery pack 1 when in the state of FIG. 24A. In the battery pack 1 in the case of the posture in FIG. 24A, due to the influence of gravitational acceleration, the detection values of the acceleration sensor 64 become −0.87 g in the Z-axis direction and 0.5 g in the Y-axis direction. The detection value in the Z-axis direction becomes a negative value because the sensor 64 is turned upside down. This falls outside the range of the operation permission range 480 described above. The control part 50 of the battery pack 1 outputs this posture information (physical information including the posture and orientation of the electrical device main body) or the battery pack information (battery pack information related to the physical information, e.g., a stop signal) that prohibits the operation of the electrical device main body 401 based on this posture information to the control part 450 of the electrical device main body 401. As a result, the operation with the electrical device main body 401 is prohibited (stopped).

The control has been described above with reference to FIG. 22A to FIG. 24C in which the control part 50 of the battery pack 1 outputs the posture information (physical information) inputted from the acceleration sensor 64 to the control part 450 of the electrical device main body 401, or outputs the battery pack information (operation permission signal or operation prohibition signal of the electrical device main body 401) related to this posture information to the control part 450 of the electrical device main body 401. With this control, it is possible to effectively prohibit an operation that operates the circular saw in an inappropriate posture using the battery pack 1 attached with a sensor. In the description with reference to FIG. 22A to FIG. 24C, the detection result in the X-axis direction has not been referred to for simplification of description, but it is also possible to perform advanced control according to further posture determination with reference to the detection results of all three axes of the X-axis, the Y-axis, and the Z-axis of the acceleration sensor 61. Further, in addition to the acceleration sensor 64, the output of any of the other sensors 63, 65, and 66 may also be used in combination to control the operation of the electrical device main body 401. Further, in step 283 of FIG. 5, by also transmitting, as the device main body information to the battery pack 1, information related to the mounting direction of the battery pack 1 with respect to the electrical device main body 401, the control part 50 of the battery pack 1 generates an operation permission signal or an operation prohibition signal as the battery pack information related to the physical information based on the physical information (posture information) inputted from the acceleration sensor 64 and the information related to the electrical device main body 401, and outputs the signal to the electrical device main body. Instead of this, since the electrical device main body 401 is aware of the mounting direction of the battery pack on itself, the control part of the battery pack 1 may also output the physical information inputted from the acceleration sensor 64 to the electrical device main body 401. In that case, the control part 450 of the electrical device main body 401 may control the operation based on information obtained based on this physical information and the mounting direction information of the battery pack on itself.

### Embodiment 4

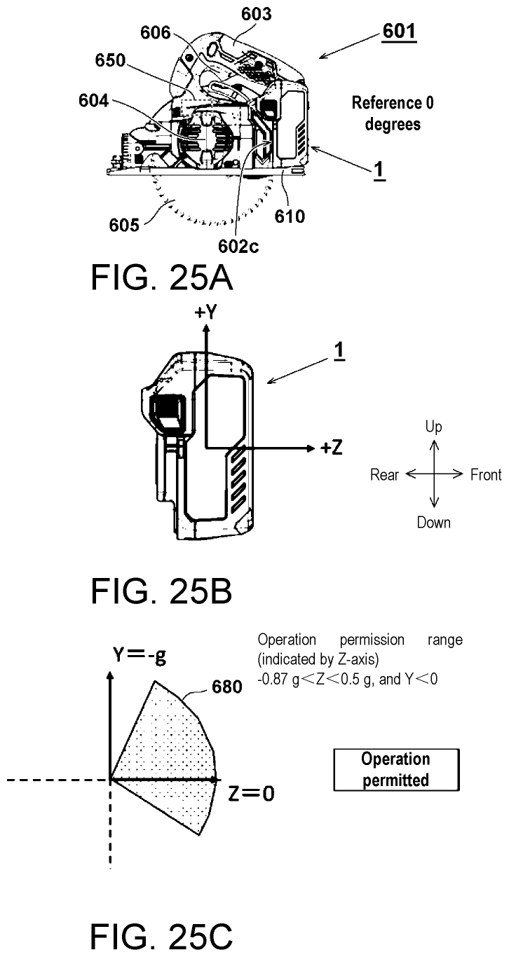

The configuration in which the battery pack 1 is slid and mounted to the electrical device main body 401 in a horizontal direction (front-rear direction) has been described with reference to FIG. 22A to FIG. 24C. Herein, the case of a configuration in which the mounting direction of the battery pack 1 with respect to an electrical device main body 601 (circular saw main body) is different will be described. In an electrical device main body 601 shown in FIG. 25A to FIG. 27C, the battery pack 1 is slid and mounted to the main body part in a vertical direction (up-to-down direction).

FIG. 25A to FIG. 25C show the case where the posture of the electrical device main body 601 is in the horizontal state, FIG. 25A is a left side view of the electrical device 601, and FIG. 25B is the posture of the battery pack 1 when in the state of FIG. 25A. The battery pack 1 is mounted to a battery pack mounting part 602c of the electrical device main body 601, for example, in a vertical state, and when the electrical device main body 601 in the horizontal state as in FIG. 25A, the battery pack 1 is in the vertical state. When a cutting operation is performed with the circular saw with the battery pack 1 in the vertical state, in the output of the acceleration sensor 64 of the battery pack 1, Y, which is a gravitational component in the +Y direction, is detected as −1 g (g is gravitational acceleration, and 1 g=9.80665 m/s²). Accordingly, it is possible to detect a tilt of the battery pack 1 with the acceleration sensor 64.

In the case where the reference direction of the Z-axis of the acceleration sensor 64 is within an operation permission range 680 (shown by diagonal lines) shown in FIG. 25C, the control part 50 of the battery pack 1 outputs posture information (physical information) inputted from the acceleration sensor 64 to the control part 650 of the electrical device main body 601, or outputs battery pack information (e.g., an operation permission signal of the electrical device main body 601) related to this posture information to the control part 650 of the electrical device main body 601. In FIG. 25C, the horizontal axis dotted line is an absolute Z-axis direction (one direction passing through a horizontal plane), and the vertical axis dotted line is an absolute Y-axis direction (one direction passing through an extending plane). In the posture of the electrical device main body 601 in FIG. 25A, due to gravitational acceleration, Y=−1 g and Z=0, which falls within the operation permission range 680 described above, so it is in the operation permission state and the operator may continue the operation with the electrical device main body 601 thereafter. Within a range in which the cutting depth can be adjusted, as described above, the electrical device main body is in a state within the operation permission range and is capable of performing the cutting operation.

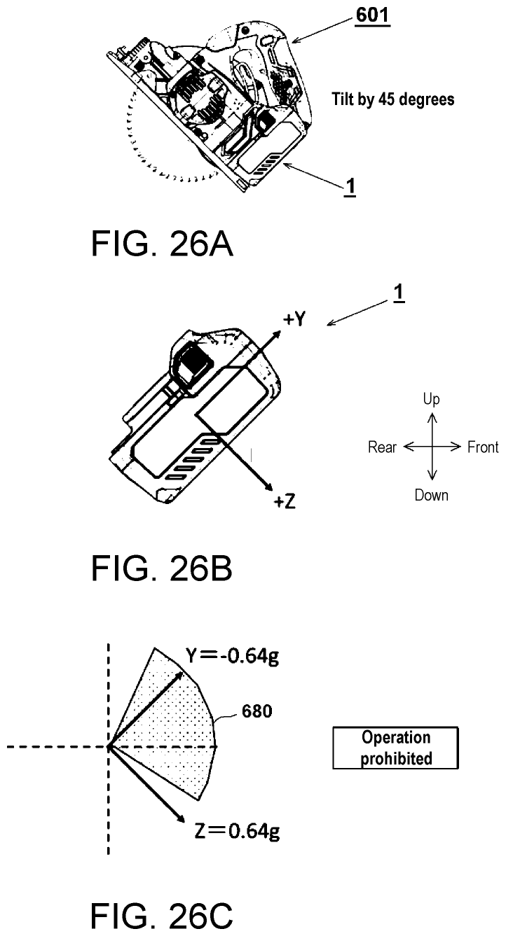

FIG. 26A to FIG. 26C are a state in which the posture on the front side of the electrical device main body 601 is tilted upward by about 45 degrees from the state in FIG. 25A. FIG. 26A is a left side view of the electrical device main body 601, and FIG. 26B is the posture of the battery pack 1 when in the state of FIG. 26A. As is clearly seen compared to the state in FIG. 25A to FIG. 25C, the detection values in the Y-axis direction and the Z-axis direction of the acceleration sensor 64 become −0.64 g in the Y-axis direction and 0.64 g in the Z-axis direction as shown in FIG. 26C. This falls outside the operation permission range 680, so the control part 50 of the battery pack 1 outputs the posture information (physical information) inputted from the acceleration sensor 64 to the control part 650 of the electrical device main body 601, or outputs the battery pack information (e.g., an operation prohibition signal of the electrical device main body 601) related to this posture information to the control part 650 of the electrical device main body 601.

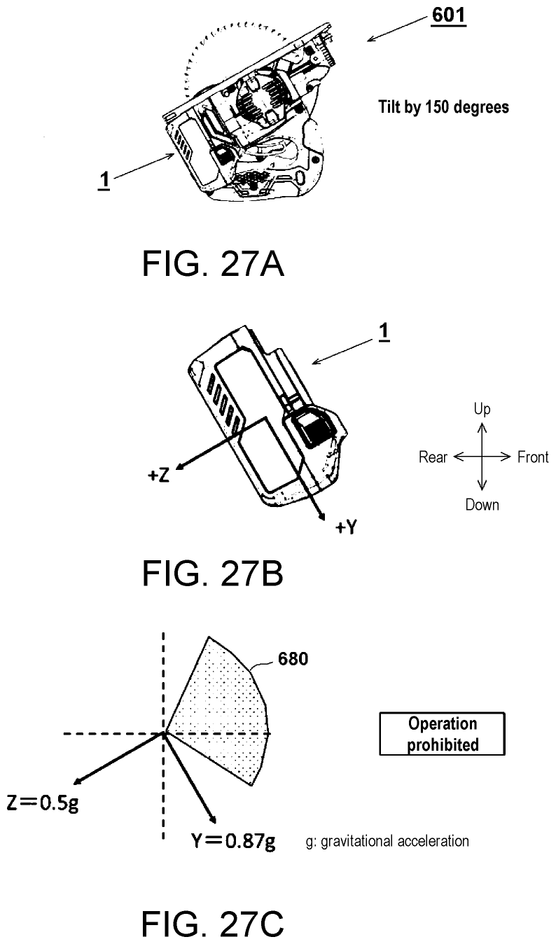

FIG. 27A to FIG. 27C are a state in which the posture of the electrical device main body has inverted and rotated by about 150 degrees from the state in FIG. 25A. This state corresponds to an operation state in which the operator uses the circular saw to cut branches of trees or cut wood on the ceiling from below. FIG. 27A is a left side view of the electrical device main body 601, and FIG. 27B is the posture of the battery pack 1 when in the state of FIG. 27A. In the battery pack 1 in the case of the posture of FIG. 27A, due to influence of gravitational acceleration, the detection values of the acceleration sensor 64 become 0.87 g in the Y-axis direction and 0.5 g in the Z-axis direction. The detection value in the Y-axis direction becomes a positive value because the acceleration sensor 64 is turned upside down. This falls outside the range of the operation permission range 680 described above. The posture information (physical information) inputted from the acceleration sensor 64 is outputted to the control part 650 of the electrical device main body 601, or the battery pack information (e.g., an operation prohibition signal of the electrical device main body 601) related to this posture information is outputted to the control part 650 of the electrical device main body 601.

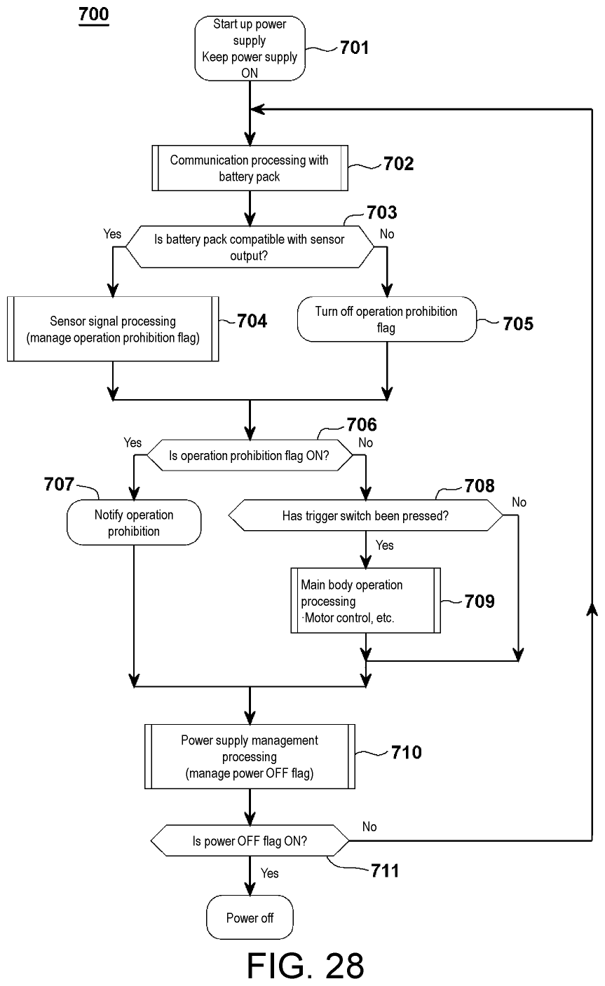

Next, the control of the control part 650 (corresponding to 250 in FIG. 3) of the electrical device main body 601 will be described with reference to a flowchart 700 in FIG. 28. When a trigger switch 606 of the electrical device main body 601 is operated with the battery pack 1 mounted on the electrical device main body 601, the power of the electrical device is turned on by startup of the control part (step 701). The control part 650 performs communication processing with the battery pack 1 via a battery communication circuit (not shown) (corresponding to 260 in FIG. 3) and a wired communication circuit (not shown) (corresponding to 261 in FIG. 3) (step 702). In the communication processing, the control part of the electrical device main body 601 receives, from the battery pack 1, battery pack information including information indicating whether the battery pack 1 is a sensor-compatible model and information detected by the acceleration sensor 64 of the battery pack 1 (corresponding to step 104 in FIG. 5), and transmits the information on the electrical device main body 601, e.g., its own model name and control parameter information, to the battery pack 1 (corresponding to step 283 in FIG. 5).

In the case where the mounted battery pack 1 is a sensor-compatible model (“Yes” in step 703), the control part 650 executes sensor signal processing based on physical information (posture information) obtained from the acceleration sensor 64 of the battery pack 1 (step 704). As described with reference to FIG. 25A to FIG. 27C, this sensor signal processing calculates whether the posture information obtained from the acceleration sensor 64 is within the operation permission range 680, and sets (turns on) an operation prohibition flag in the case of falling outside the operation permission range 680 (step 704). The control part 650 sets the operation permission range 680 based on the mounting direction of the battery pack 1 with respect to its electrical device main body 601. An operation permission flag may also be set if falling within the operation permission range 680. On the other hand, in the case where the battery pack 1 is a sensor-incompatible model (“No” in step 703), an operation prohibition flag is reset (turned off) (step 705).

Next, in the case where the operation prohibition flag has been set (“Yes” in step 706), the control part 650 prohibits driving of the electrical device main body, notifies the operator of operation prohibition, for example, by an LED (step 707), and ends the control (step 710). On the other hand, in the case where the operation prohibition flag has not been set (“No” in step 706), it is determined whether the trigger switch has been operated to execute the normal operation (step 708), and if the trigger switch has been operated (“Yes” in step 708), processing that operates the electrical device main body (motor) is executed (step 709). If the trigger switch has not been operated (“No” in step 708), the control is ended (step 710). Finally, the control part 650 determines whether a power OFF flag has turned on (step 711), and if turned on (“Yes” in step 711), the control part 650 turns off the power of the electrical device main body 601 by releasing its own power hold. In the case where the power OFF flag has not turned off in step 711 (“No” in step 711), the process returns to step 702.

The control procedure in the configuration in which the battery pack 1 is mounted to the electrical device main body 601 in the up-down direction has been described above. However, the mounting direction of the battery pack 1 with respect to the electrical device main body is not limited thereto, and the control procedure in FIG. 28 may be similarly applied to the electrical device main body 401 of the configuration of mounting in the front-rear direction as in the third embodiment shown in FIG. 22A to FIG. 24C, and further, may be similarly applied to an electrical device main body to which the battery pack 1 is mounted in a left-right direction or a diagonal direction. Further, the number of battery packs 1 capable of being mounted at the same time to the electrical device main bodies 401 and 601 is not limited to one, but may also be plural. Whether the mounting directions of a plurality of battery packs 1 are the same as or different from each other, by configuring to transmit physical information of the acceleration sensor in each battery pack or battery pack information related to the physical information to the electrical device main body 401 and 601 side, the control part of the electrical device main bodies 401 and 601 is capable of controlling its own operation based on the sensor information and information that can be detected by itself (e.g., mounting direction information of the battery pack 1).

### Embodiment 5

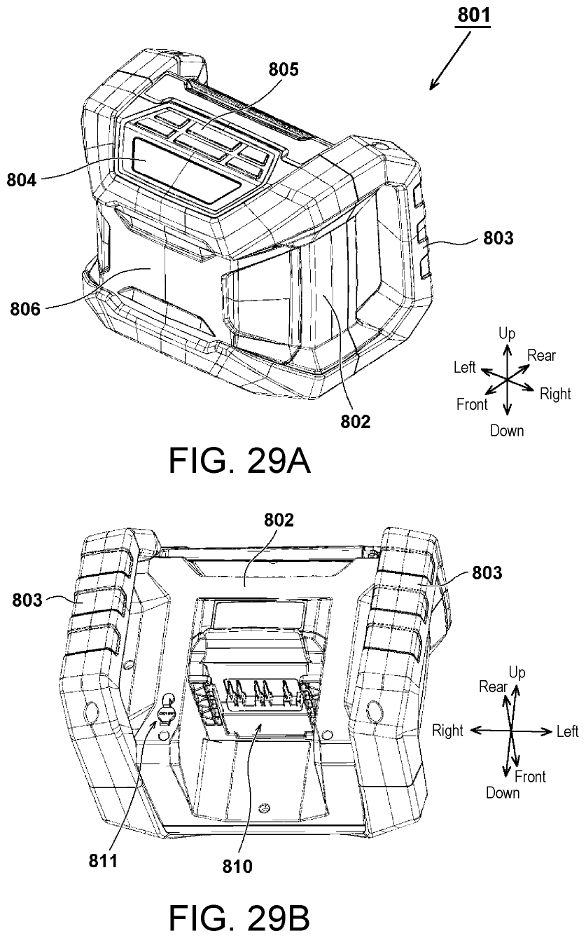

Next, a fifth embodiment of the present invention will be described with reference to FIG. 29A and FIG. 29B. FIG. 29A and FIG. 29B are external views of a specific device as an electrical device main body 801, and herein, an example of a radio is shown. FIG. 29A is a perspective view of the electrical device main body 801 viewed from a front upper side. Taking the battery pack 1 as a power source, the electrical device main body 801 has a first mode (volume automatic adjustment mode) that automatically adjusts a volume (output value) outputted from a speaker 806 according to a magnitude of the surrounding sound. The fifth embodiment is not limited to a radio but may also be widely applied to a television and other audio devices capable of adjusting the volume.

A radio main body 801 as an electrical device main body includes a handle 803 that is held by a user, an operation panel 805 that is operated by the user and has a power button, a volume adjusting button, a mode switching button, and a channel switching button, a display part 804 that is composed of a liquid crystal screen displaying a volume and a channel, and a speaker 806 that is provided at a front surface of the main body. FIG. 29B is a perspective view of the electrical device main body 801 viewed from a rear lower side, and a battery pack mounting part 810 for mounting the battery pack 1 is provided on a back side of a housing 802 of the radio main body 801. A shape of the battery pack mounting part 810 is identical (compatible) to the battery pack mounting part 202c shown in FIG. 1, rail parts including grooves or rails extending in parallel in the front-rear direction are formed at inner wall portions on both left and right sides, and a terminal part (main body-side terminal part) is provided therebetween. An AC adapter connection part 811 for connecting a connector of an AC adapter (not shown) is provided in the vicinity of the battery pack mounting part 810.

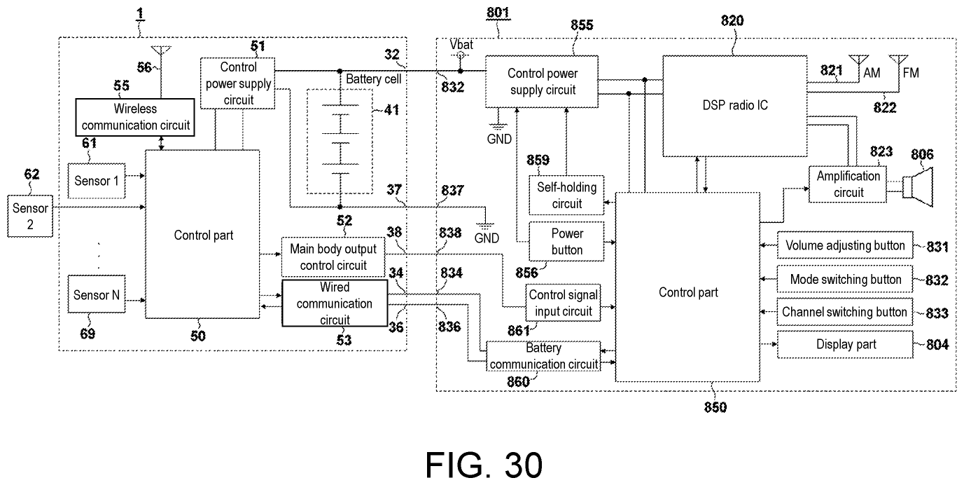

FIG. 30 is a block diagram showing a configuration of the electrical device main body 801. The configuration of the battery pack 1 shown on the left side is the same as the configuration shown in FIG. 3, so repeated descriptions will be omitted by labeling with the same reference signs. The electrical device main body 801 is a radio that detects, by a DSP radio IC 820, radio waves received by an AM antenna 821 and an FM antenna 822, and amplifies the radio waves by an amplification circuit 823 to output audio from the speaker 806. The electrical device main body 801 includes a control part 850 to perform communication with the control part 50 included in the battery pack 1. The electrical device main body 801 is provided with a positive electrode input terminal 832 and a negative electrode input terminal 837, which are respectively connected to the positive electrode terminal 32 and the negative electrode terminal 37 of the battery pack 1. Although a positive electrode terminal for charging (so-called C+ terminal) is provided as a power terminal at the battery pack 1, it is not shown herein.

The electrical device main body 801 is provided with a first signal terminal (T terminal) 834, a second signal terminal (LS terminal) 836, and a third signal terminal (LD terminal) 838 that are connected to the T terminal 34, the LS terminal 36, and the LD terminal 38 on the battery pack 1 side. A control signal input circuit 861 is connected to the third signal terminal (LD terminal) 838. The control signal input circuit 861 determines on a signal transmitted from the battery pack 1 side and outputs to the control part 850. A battery communication circuit 860 is connected to the first signal terminal (T terminal) 834 and the second signal terminal (LS terminal) 836, and performs bidirectional wired communication with the wired communication circuit 53 of the battery pack 1 using signal terminals including the LS terminals 36 and 836 and the T terminals 34 and 834.

The DSP radio IC 820 is one IC that incorporates all the functions necessary for receiving AM and FM radio by performing digital calculation on analog signals inputted from the AM antenna 821 and the FM antenna 822 using a processor, and may use a commercially available product. The DSP radio IC 820 outputs an audio signal to the amplification circuit 823. When a power button 856 is operated by a user, a drive power supply is supplied from the control power supply circuit 855 to the control part 850, the DSP radio IC 820, the amplification circuit 823, etc., and the electrical device main body 801 starts up. After the control part 850 starts up, a signal for keeping the control power supply circuit 855 in an on state is continuously outputted by the self-holding circuit 859, and power supply from the control power supply circuit 855 to the control part 850 is maintained.

Output signals from various buttons (831 to 833) provided at the operation panel 805 are transmitted to the control part 850. A volume adjusting button 831 is an operation button for adjusting the magnitude of sound outputted from the speaker 806, and is composed, for example, of two buttons including a “+ button” (volume increase) and a “− button” (volume decrease). A mode switching button 832 is operated when switching between a volume automatic adjustment mode (first mode) and a normal mode (second mode) according to this embodiment. In the “normal mode”, the control part 850 adjusts the volume according to the user's operation on the volume adjusting button (adjustment part) 831, and in the “volume automatic adjustment mode”, the control part 850 adjusts the volume by increasing and decreasing the output from the amplification circuit 823 according to the magnitude of the surrounding sound acquired from a sensor such as a microphone provided at the battery pack 1. A channel switching button 833 is a switching button for switching broadcast channels set in a storage device of the control part 850. The display part 804 is a conventional dot matrix display means such as a liquid crystal display device, and visually displays various information such as channel display, volume display, and mode display indicating whether the mode is the “normal mode” or the “volume automatic adjustment mode”.

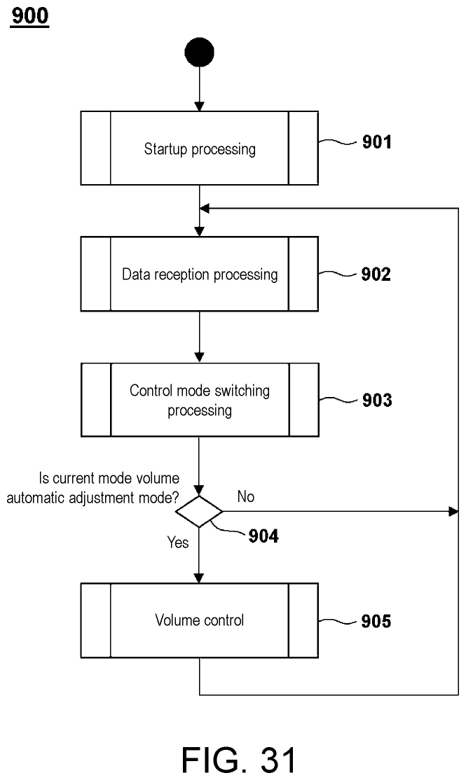

FIG. 31 is a flowchart (900) showing an operation of the control part 850. When the power button 856 (refer to FIG. 30) is operated, the control part 850 executes startup processing (step 901). Thereafter, the control part 850 executes processing of data and operations received via the battery communication circuit 860, the control signal input circuit 861, and various buttons of the operation panel 805 (refer to FIG. 30) (step 902), and executes control mode switching processing (step 903). In the case where the volume automatic adjustment mode has been set as the current control mode by an operation of the mode switching button (“Yes” in step 904), volume control is executed to automatically adjust the volume according to the surrounding sound (step 905), and the process returns to step 902. On the other hand, in the case where the current control mode is the normal mode which is not the volume automatic adjustment mode (“No” in step 904), the control part 850 adjusts to the volume set according to the operation of the volume adjusting button 831 and returns to step 902.

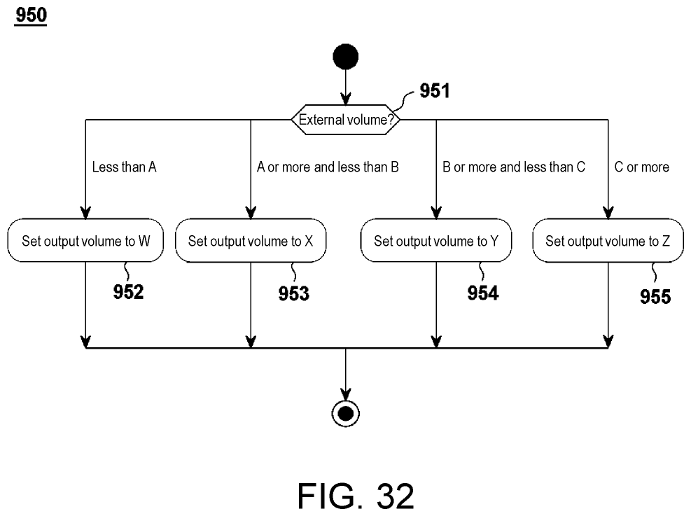

Next, a detailed procedure of the volume control in step 905 of FIG. 31 will be further described with reference to the flowchart in FIG. 32. In the case where the “volume automatic adjustment mode” has been set, the control part 850 automatically adjusts the output volume (amplification factor of the amplification circuit 823) from the speaker 806 according to the surrounding sound (external volume) received by the sound sensors 63 to 66. Herein, the sound pressure level from outside acquired from the sound sensors 63 to 66 of the battery pack 1 are calculated. Herein, auditory correction may be performed to adjust the size for each frequency, and the results may be totaled and calculated. In the case where the sound pressure level of the calculated external volume is less than a threshold A, the control part 850 sets the output volume to W (step 952), and in the case where the external volume is equal to or greater than the threshold A and less than a threshold B, the control part 850 sets the output volume to X (step 953). The sound pressure level compared with the threshold A, etc. may be appropriately set according to a method of comparing by a peak value of sound pressure, a method of comparing by an average value, a method of comparing by a sound pressure value weighted at specific frequencies and times, etc. Furthermore, in the case where the external volume is equal to or greater than the threshold B and less than a threshold C, the control part 850 sets the output volume to Y (step 954), and in the case where the external volume is equal to or greater than the threshold C, the control part 850 sets the output volume to Z (step 955). Herein, the output volume has a relationship of W<X<Y<Z.

In the radio 801 shown in FIG. 29A and FIG. 29B, as in the light 301 shown in FIG. 11, a variable mechanism may also be added to automatically rotate the speaker 806 to face a direction where external sound is generated or a direction where the sound is loud. Further, the variable part and the variable setting on the electrical device main body side shown in the fifth embodiment may be configured to be adjusted based on the signal detected by the sensor of the battery pack 1. For example, in the light 301 shown in FIG. 11, not only the irradiation direction but also the illuminance of the light 301 may be automatically adjusted according to the brightness of the surroundings. Furthermore, a fan driven by the battery pack 1 may also be used as an electrical device main body, and in that case, it is possible to automatically adjust an angle of a direction of wind from the fan to the direction of a user using a human detecting sensor provided at the battery pack 1, or it is possible to configure to automatically adjust a wind volume of the fan according to the surrounding temperature measured by a temperature sensor provided at the battery pack 1.

Although the present invention has been described based on the embodiments, the present invention is not limited to these embodiments and various changes may be made without departing from spirit thereof. For example, the setting of the sound detection mode in FIG. 21 may also be configured to be changed by a “control mode change request” from an external device (e.g., a smartphone) via wireless communication of the battery pack.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. The electrical device according to claim 21, further comprising an adjustment part that is operated by a user and adjusts an output of the output part, wherein
the device-side control part is configured to control the output part according to one of a first mode that controls the output part based on the information related to the sound and a second mode that controls the output part based on an operation on the adjustment part.

15. An electrical device comprising:
a battery pack;
an electrical device main body which comprises a battery pack mounting part to which the battery pack is capable of being mounted, and a load part driven by the battery pack;
a sensor part disposed at the battery pack, and configured to collect and output physical information that arises due to external factors of the battery pack; and
a control part that is connected to the sensor part, and is configured to determine posture of the battery pack or the electrical device main body based on the physical information,
wherein the control part is configured to prohibit driving the load part in a case where the posture falls outside an operation permission range.

16. The electrical device according to claim 15,
wherein, the control part is configured to determine whether the posture falls outside the operation permission range based on an information related to a mounting direction of the battery pack with respect to the battery pack mounting part and the physical information.

17. The electrical device according to claim 16,
wherein the information related to the mounting direction comprises the operation permission range based on the mounting direction of the battery pack in a state in which the electrical device main body is normally placed.

18. An electrical device comprising:
a battery pack;
an electrical device main body which comprises a battery pack mounting part to which the battery pack is capable of being mounted, and an irradiation part driven by the battery pack;
a sensor part disposed at the battery pack, and configured to collect and output physical information that arises due to external factors of the battery pack; and
a control part that is connected to the sensor part, and is configured to control the irradiation part based on the physical information,
wherein the physical information includes first information related to brightness of the surroundings,
the control part is configured to change illuminance of the irradiation part based on the first information.

19. The electrical device according to claim 18,
wherein the physical information includes second information related to sound generated around the electrical device main body or the battery pack,
the control part is configured to change an irradiation direction of the irradiation part based on the second information.

20. The electrical device according to claim 19,
wherein the control part is configured to control the irradiation part facing in a direction generating sound.

21. An electrical device comprising an electrical device main body and a battery pack mountable to the electrical device main body, wherein,
the electrical device main body comprises:
a battery pack mounting part to which the battery pack is capable of being mounted;
an output part that is capable of outputting light or sound and is capable of rotation; and
a device-side control part that controls rotation of the output part, the battery pack comprising:
a sensor part configured to collect and output physical information that arises due to external factors of the battery pack; and
a battery pack control part that is connected to the sensor part, and is configured to output the physical information inputted from the sensor part to the electrical device main body, or generate and output battery pack information related to the physical information to the electrical device main body,
wherein the physical information comprises information related to sound generated around the electrical device main body or the battery pack, and
the device-side control part is configured to change an output direction or an output value of the light or the sound of the output part based on the information related to the sound.
